(19) United States
(12) Patent Application Publication
(10) Pub. No.: US 2026/0289170 A1
(43) Pub. Date: Sep. 24, 2026

(54) SYSTEM

(71) Applicant: SoftBank Group Corp., Tokyo (JP)

(72) Inventor: Shoko FUNAKI, Tokyo (JP)

(73) Assignee: SoftBank Group Corp., Tokyo (JP)

(21) Appl. No.: 19/564,275

(22) Filed: Mar. 12, 2026

(30) Foreign Application Priority Data
Mar. 19, 2025 (JP) 2025-044985

(51) Int. Cl. G06F 40/40; G06F 40/166; G06T 11/60; G06V 10/764

(52) U.S. Cl. CPC G06F 40/40; G06F 40/166; G06T 11/60; G06V 10/764

(57) ABSTRACT

A system includes a processor that is configured to capture, for each product item, required product images at specified angles and in specified numbers, store the captured product images and associated detailed information in a database, input, based on the stored product images and the detailed information, a prompt to a generative AI model to cause the generative AI model to generate at least one of a product description text and an advertising copy, transmit the generated product description text or the generated advertising copy to a terminal of a user, and upload confirmed and corrected product information to a web server for publication.

### CROSS-REFERENCE TO RELATED APPLICATION

This application is based on and claims priority under 35 USC 119 from Japanese Patent Application No. 2025-044985 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional e-commerce systems require store operators to manually prepare product description texts and advertising copies based on product images and detailed information. This manual work is time-consuming, depends heavily on individual skills, and often leads to inconsistent quality and effectiveness of product pages and advertisements. Furthermore, although generative AI models have become available, there is no integrated mechanism in typical systems to automatically generate appropriate prompts from stored product images and detailed information, to obtain suitable product descriptions and advertising copies, and to present these results to a user in a manner that allows efficient confirmation, correction, and publication. As a result, it is difficult to systematically improve the efficiency and quality of content creation for product listings and advertisements, and to streamline the entire workflow from product image capture through public release on a web server.

### SUMMARY

In order to solve the above-described problems, the present invention provides a system comprising a processor, wherein the processor is configured to capture, for each product item, required product images at specified angles and in specified numbers, and to store the captured product images and associated detailed information in a database. The processor is further configured to input, based on the stored product images and the detailed information, a prompt to a generative AI model to cause the generative AI model to generate at least one of a product description text and an advertising copy, and to transmit the generated product description text or the generated advertising copy to a terminal of a user. The processor is also configured to upload confirmed and corrected product information to a web server for publication. In one aspect, the processor generates the prompt so as to include keywords extracted from the product images and the detailed information, and inputs the generated prompt to the generative AI model. In another aspect, the processor causes the product information to be published in response to a user performing a publication setting and operating a publication button through a management screen of an information processing device. By these means, the system automates and integrates the sequence from structured product image capture, through AI-based generation of product descriptions and advertising copies, to user-assisted correction and final publication on a web server, thereby improving efficiency and consistency in e-commerce content creation.

The term “system” refers to an arrangement including at least one processor and associated components, such as memory, storage, databases, communication interfaces, and software, that cooperatively execute the functions described in the claims.

The term “processor” refers to a hardware device or a combination of hardware and software components, such as a CPU, GPU, microcontroller, or computing node, configured to execute instructions to perform the processing operations described in the claims.

The term “product item” refers to a good or service that is offered or intended to be offered for sale or distribution and for which product images, detailed information, and product information are managed by the system.

The term “product image” refers to a digital image file or representation depicting at least a portion or view of a product item, including images captured at different angles and under different conditions for use in product descriptions and advertisements.

The term “specified angle” refers to a predetermined or designated viewing angle or orientation with respect to a product item at which a product image is to be captured.

The term “specified number” refers to a predetermined or designated count of product images to be captured for a product item, optionally per angle, category, or other condition.

The term “detailed information” refers to structured or unstructured information associated with a product item, including, for example, a product name, price, material, size, category, attributes, specifications, and descriptive text.

The term “database” refers to any logical or physical data storage system, such as a relational database, NoSQL database, or other persistent storage, that stores product images, detailed information, prompts, and associated records.

The term “prompt” refers to an input text, data structure, or set of instructions that is provided to a generative AI model to specify the content, style, or constraints for generating at least one of a product description text and an advertising copy.

The term “generative AI model” refers to a machine learning model, such as a large language model or multimodal generative model, which is configured to generate natural language text or other content in response to a prompt.

The term “product description text” refers to natural language text describing characteristics, features, specifications, usage, or advantages of a product item for display on a product page or similar interface.

The term “advertising copy” refers to natural language text intended for use in advertisements or promotional materials to attract potential customers to a product item.

The term “terminal” refers to an information processing device operated by a user, such as a personal computer, smartphone, tablet, or other client device, that communicates with the system to display, receive, and transmit information.

The term “user” refers to a human operator, such as a store operator, administrator, or content creator, who interacts with the system via the terminal to manage product items, review outputs, and control publication settings.

The term “product information” refers to information to be published regarding a product item, including at least one of the product images, detailed information, product description text, and advertising copy, as confirmed and optionally corrected by the user.

The term “web server” refers to a server or group of servers configured to host and deliver web pages or web-based content, including product information, over a network such as the Internet.

The term “publication” refers to making product information accessible to external viewers or customers via a web server or similar distribution channel.

The term “keywords” refers to words, phrases, or tokens extracted from product images and detailed information, or derived therefrom, which represent important attributes, features, or concepts related to a product item and are used as part of a prompt.

The term “management screen” refers to a graphical user interface or control interface presented on a terminal or other information processing device, through which a user can perform management operations such as setting publication options, reviewing generated content, and executing publication.

The term “publication setting” refers to a configuration or selection made by a user, via the management screen, indicating how, when, and where product information is to be made publicly accessible.

The term “publication button” refers to a user interface element, such as a button, icon, or control, which, when operated by the user, instructs the system to initiate or confirm the publication of product information.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

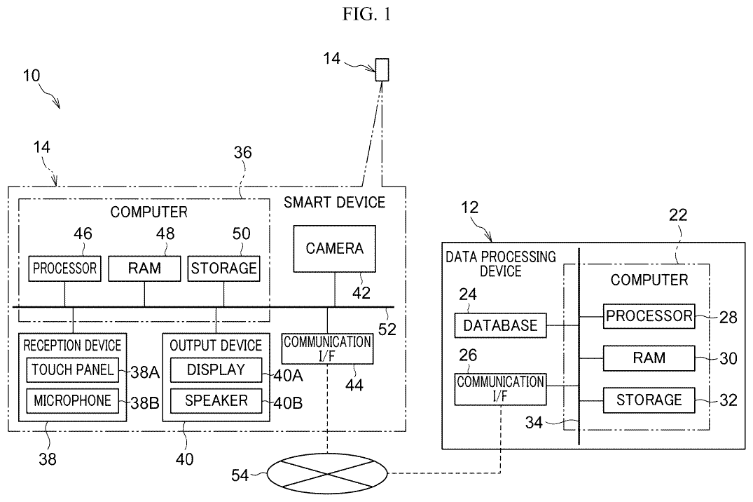

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

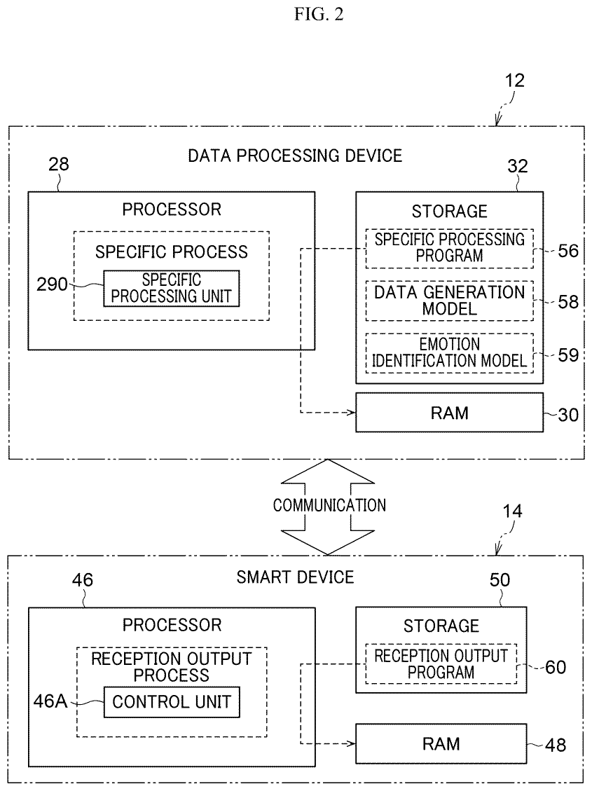

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional electronic commerce authoring workflows require human operators to manually compose and manage textual product information, such as product descriptions and advertising texts, for each merchandise item. Even when general-purpose text editors and web-based management screens are used, a processor in such systems typically treats images, attribute data, and textual content as loosely coupled resources, without any integrated mechanism for automatically deriving prompt sentences for a generative AI model, or for structurally managing generated and edited text in association with image data and attribute data. As a result, the processor expends substantial computing resources on repetitive data transfers, redundant validations, and manual review cycles, and cannot effectively optimize memory access patterns or network interactions related to text generation and publication.

Further, in many existing systems that invoke a generative AI model, the construction of prompt sentences is either manually performed by a user or hard-coded in an inflexible manner. Such systems do not systematically extract structured feature terms (for example, material, color, dimension, price, classification, and usage scene) from a data set that binds merchandise images and attribute information, and therefore cannot leverage the full potential of machine-generated text. This leads to suboptimal utilization of the generative AI model, higher latency in generating product information, and inconsistent quality of generated text. The lack of a structured linkage between a data set and prompt sentence formation also complicates database schema design and cache strategies, resulting in inefficient memory management and increased processor load.

Moreover, conventional content management systems for online stores often provide only coarse-grained publication controls, where a user must manually copy and paste generated text and separately toggle publication states across multiple interfaces. In such architectures, a processor is not configured to treat generation, review, correction, and publication of merchandise information as a single, coherent pipeline controlled through a management screen. This fragmentation causes unnecessary input/output operations between application layers, increases synchronization overhead between generated and final text, and makes it difficult to maintain consistency and traceability of edits in a storage device.

Accordingly, there is a need for a technical solution in which a processor in an information processing apparatus is specifically configured to (i) acquire merchandise images and structured attribute information, (ii) normalize and associate such data in a data set, (iii) automatically construct prompt sentences containing extracted feature terms for a generative AI model, (iv) receive and manage generated text in a structured manner, and (v) control publication states through a unified management screen. By tightly integrating these functions at the processor and data-structure level, the system can improve the efficiency, reliability, and scalability of computer-implemented operations for generating, editing, and publishing merchandise information, thereby improving the functioning of the computer system itself.

The specific processing by the specific processing unit 290 of the data processing device 12 in Example 1 is realized by the following means.

The present invention provides a server comprising a processor configured to receive, from a terminal via a communication network, merchandise images and structured attribute information for each merchandise item, to perform image processing on the merchandise images by using image processing software so as to convert the merchandise images into predetermined image formats and resolutions, to register the processed merchandise images and the attribute information in association with each merchandise item in a data set stored in a storage device, to extract, from the data set, keyword information and numerical information representing characteristics of the merchandise item, to automatically construct a prompt sentence by inserting extracted feature terms into a sentence template so as to form instruction information for a generative AI model, to transmit the prompt sentence to the generative AI model and obtain generated text including at least one of a product description and an advertising short text corresponding to the merchandise item, to store the generated text in the data set in association with the merchandise item, to provide the generated text to the terminal in a format suitable for display in a management screen, to receive, from the terminal through the management screen, correction information for the generated text and update the data set with corrected text, and to receive, from the terminal, state information indicating a publication state of merchandise information reflecting the corrected text and, based on the state information, make the merchandise information distributable as publication information via a web provision interface. This enables an integrated computer-implemented pipeline in which acquisition, normalization, prompt sentence generation, AI-based text generation, user correction, and controlled publication of merchandise information are executed in a coordinated manner by the processor and the structured data set, thereby reducing redundant processing, improving the utilization efficiency of the generative AI model, enhancing data consistency, and improving overall system performance in generating and managing product-related digital content.

The term “processor” refers to a hardware-based or virtual computing element, such as a central processing unit, a microprocessor, or a processing core, that executes instructions to perform the functions described in the present disclosure.

The term “terminal” refers to an information processing device, such as a personal computer, a tablet device, or a mobile communication device, that is operated by a user to transmit data to and receive data from a server via a communication network.

The term “merchandise item” refers to an article, good, or product that is handled in an electronic commerce environment and for which images, attributes, and textual information are managed by the system.

The term “merchandise image” refers to digital image data representing a visual appearance of a merchandise item, obtained by capturing the merchandise item through an imaging device under predetermined imaging conditions.

The term “attribute information” refers to structured data associated with a merchandise item, including but not limited to material, color, dimension, price, classification, and usage scene, which is stored in a data structure and used for text generation and display.

The term “structured attribute information” refers to attribute information represented in a predefined data format, such as key-value pairs, database records, or tagged fields, that can be programmatically parsed and processed by the processor.

The term “imaging conditions” refers to parameters for capturing merchandise images, including at least one of shooting angle, number of images, distance to the merchandise item, lighting conditions, and background configuration.

The term “image processing software” refers to a software component or library executed by the processor to perform operations on digital images, such as format conversion, resizing, resolution adjustment, compression, and thumbnail generation.

The term “conversion processing” refers to operations performed on a merchandise image to transform its format, size, resolution, or other characteristics so that the image conforms to predetermined standards used by the system.

The term “data set” refers to a collection of related data records stored in a storage device, including at least merchandise images, attribute information, and generated texts, which are associated with corresponding merchandise items.

The term “storage device” refers to a non-transitory computer-readable medium, such as a magnetic disk, a solid state drive, an optical disk, or a semiconductor memory, that stores the data set and other information used by the processor.

The term “communication network” refers to a wired or wireless network infrastructure, such as the Internet, a local area network, or a wide area network, through which the terminal and the server exchange data.

The term “keyword information” refers to one or more words or phrases extracted from merchandise images, attribute information, or other data, which represent features or characteristics of a merchandise item and are used in prompt sentence construction.

The term “numerical information” refers to data values expressed as numbers, including but not limited to prices, dimensions, weights, and quantities, which describe quantitative characteristics of a merchandise item.

The term “feature term” refers to a keyword, phrase, or numerical expression corresponding to a specific characteristic of a merchandise item, such as material type, color name, size indication, price value, classification label, or usage context.

The term “sentence template” refers to a predefined textual pattern that includes placeholders into which feature terms are inserted by the processor to generate a prompt sentence.

The term “prompt sentence” refers to a text string constructed by the processor, including feature terms and contextual instructions, which is transmitted as input to a generative AI model to request generation of product-related text.

The term “generative AI model” refers to a software-based machine learning model, such as a neural network-based language model, that receives a prompt sentence and outputs generated text based on learned statistical relationships in training data.

The term “generated text” refers to text data produced by the generative AI model in response to a prompt sentence, including at least one of a product description, an advertising short text, or other product-related textual content.

The term “product description” refers to a generated or edited textual explanation describing features, benefits, specifications, and usage of a merchandise item, intended for display to potential purchasers.

The term “advertising short text” refers to a relatively short piece of generated or edited text intended to attract attention or promote a merchandise item, such as a slogan, tagline, or brief promotional phrase.

The term “management screen” refers to a user interface provided to the terminal, typically through a web browser or application, that allows a user to view, edit, and control merchandise information including generated text and publication states.

The term “correction information” refers to edit data or modification instructions input by a user through the management screen to alter or refine the generated text stored in the data set.

The term “state information” refers to data indicating a status of merchandise information within the system, including at least a publication state representing whether the merchandise information is ready for distribution or is already distributed.

The term “publication state” refers to a state indicated by the state information, including at least a non-published state and a published state, that determines whether merchandise information is made externally available.

The term “publication information” refers to merchandise information, including images, attributes, and final textual content, that is designated by the system as distributable to external clients or end users.

The term “web provision interface” refers to a programmatic or web-based interface, such as an application programming interface or a web server endpoint, through which publication information is distributed to external systems or user devices.

The term “server” refers to an information processing apparatus, including at least the processor and the storage device, that executes the functions of acquiring, processing, storing, generating, and distributing merchandise-related data as described herein.

In the following embodiments, a server, a terminal, and a user cooperate to implement the claimed system. The server includes at least one processor, a memory, a storage device, a network interface, and execution modules for image processing, data management, prompt construction, communication with a generative AI model, and management-screen control. The terminal includes at least one processor, a display, input devices, and a network interface. The user operates the terminal.

### 1. Overall System Configuration

The server provides a network-accessible application for managing merchandise information. The server executes an operating system such as a general-purpose server operating system and runs application software including a web server module, an application server module, a database management module, an image processing module, and a generative-AI interaction module. The server uses a storage device such as a solid-state drive or a magnetic disk drive to store a data set that associates merchandise images, attribute information, and generated texts.

The terminal executes a browser application or a dedicated client application and communicates with the server over a communication network such as the Internet using a protocol such as HTTPS. The terminal renders user interfaces for uploading images and attribute information, for reviewing and correcting generated texts, and for setting publication states. The user operates the terminal via a keyboard, a pointing device, or a touch panel to input data and issue commands to the server.

### 2. Hardware and Software Components

The server uses a central processing unit (CPU) or a combination of a CPU and an accelerator (for example, a graphics processing unit) to execute software components. The server uses an image processing library corresponding to an image processing software (for example, an implementation comparable to ImageMagick) to perform format conversion, resizing, and compression of merchandise images.

The server uses a relational or document-oriented database system, such as a system comparable to a relational database management system or a document store, to implement the data set. The server defines database structures including at least:
A merchandise table or collection containing fields such as merchandise identifier, title, classification identifier, base price, and publication state.
An attribute table or collection containing structured attribute information such as material, color, dimension, weight, usage scene, and other key-value pairs.
An image table or collection containing paths or URLs of processed images, resolutions, aspect ratios, and associated merchandise identifiers.
A generated-text table or collection containing fields for prompt sentences, raw generated product descriptions, raw generated advertising short texts, corrected descriptions, corrected advertising short texts, and timestamps.

The server uses a generative-AI interaction module that communicates with an external or internal generative AI model via an application programming interface. The generative AI model is implemented as a large-scale neural network language model. In one embodiment, the generative AI model has a transformer-based architecture with multiple self-attention layers, feed-forward layers, and layer normalization units. The model parameters include weight matrices and bias vectors learned from large-scale text corpora. The model uses tokenization to convert a prompt sentence into sequences of tokens and uses attention-based computation to produce probability distributions over next-token candidates.

### 3. Data Structures and Associations

The server defines a data set in the storage device as a set of interlinked records. The server associates each merchandise item with:
One or more merchandise images, each with metadata such as resolution, file size, color histogram, and viewpoint tag.
Structured attribute information, represented as normalized fields or key-value pairs for material, color, dimension, price, classification, and usage scene.
One or more generated-text records, each containing a prompt sentence, a generated product description, a generated advertising short text, and corresponding corrected versions.

The server configures indexes over merchandise identifiers, classification identifiers, and key attribute fields. The server thereby reduces lookup latency when constructing prompt sentences and when retrieving generated texts for display in the management screen. The server stores prompt sentences themselves in the data set to allow reproducibility of AI outputs and to support later analysis of prompt-output correlations.

### 4. Image acquisition and processing

The user captures merchandise images using an imaging device such as a digital camera or a smartphone. The user adjusts imaging conditions including angle, distance, and lighting. For example, the user captures a merchandise item from a 45-degree angle three times and from a 90-degree side angle two times.

The terminal transmits the captured images to the server. The server receives the merchandise images in formats such as JPEG or PNG. The server invokes the image processing software to:
Convert image formats to a standardized format, for example to a baseline JPEG format with a predetermined compression level.
Resize images to multiple fixed resolutions (for example, a main image of 1024×1024 pixels and a thumbnail of 256×256 pixels).
Optionally normalize color profiles to a standard color space.

By enforcing unified image formats and sizes, the server reduces the variety of image data handled by downstream modules and allows caching and content-delivery optimizations. This unified treatment reduces memory fragmentation, enables better cache locality when serving images, and improves throughput of the web provision interface.

### 5. Attribute Information Management

The user inputs structured attribute information through the terminal's management screen. The terminal sends the attribute information in a structured format such as key-value pairs or form-encoded data. The server validates that attribute fields adhere to predetermined formats, such as numeric types for price and dimension and controlled vocabularies for classification and usage scenes.

The server normalizes synonyms and variant expressions (for example, mapping “leather” and “genuine leather” to a canonical material code) and stores both the canonical code and the original label in the data set. This normalization allows the server to systematically generate prompt sentences without having to interpret free-form text at generation time and improves consistency of language used in generated descriptions.

### 6. Prompt Sentence Construction and Technical Details

The server constructs a prompt sentence based on attribute information and merchandise-image metadata. The server extracts feature terms by applying rule-based and statistical analyses. For example, the server identifies material terms from a material field, extracts numeric dimension values from a dimension field, and maps classification codes to human-readable category names.

The server optionally computes simple image-derived features such as dominant color from image histograms and uses these as additional feature terms in the prompt sentence. The server inserts these feature terms into a predefined sentence template. Examples of such prompt sentences include:
“Generate a detailed product description for a red leather handbag. Material: genuine leather. Size: 30 cm×20 cm×10 cm. Price: 18,000 yen. Describe the design, quality, and recommended usage situations in natural, appealing language.”
“Create three short advertising copy lines for an online advertisement promoting a red leather handbag made of genuine leather, highlighting elegance and durability.”

The server uses different templates for product descriptions and advertising short texts, adjusting the structure of the prompt sentence to elicit text of appropriate length and style. By embedding structured feature terms into the prompt sentence, the server avoids relying on unstructured manual prompts and reduces errors caused by omitted or inconsistent product attributes.

The generative AI model receives the prompt sentence and performs internal computation. In one embodiment, the model uses a transformer-based language model comprising stacked self-attention layers. The server provides configuration parameters such as:
A model identifier specifying the parameter set.
A temperature parameter controlling randomness of token sampling.
A maximum token count limiting the length of the generated text.

The model computes attention scores between all token positions in the prompt and in the partially generated output. The model multiplies attention scores by value vectors and aggregates them to produce context-sensitive representations at each position. A final linear layer and softmax function convert these representations into probability distributions over vocabulary tokens. The server uses a decoding algorithm such as top-k or nucleus sampling to select output tokens.

Because the prompt sentence contains highly structured feature terms, the model's attention mechanism can more precisely relate specification tokens (for example, dimensions and price) to descriptive phrases, which improves factual consistency and reduces hallucination. The server leverages this behavior to produce more reliable product information than could be achieved by ad-hoc, free-form prompts.

### 7. Training and Adaptation of the Generative AI Model

In one embodiment, the generative AI model is pre-trained on a large corpus of general text using an unsupervised language modeling objective that minimizes cross-entropy between predicted tokens and ground-truth tokens. The model is then fine-tuned on domain-specific data, such as pairs of attribute sets and human-authored product descriptions.

The server can maintain a fine-tuning dataset in the data set by storing user-corrected texts alongside the original prompt sentences and generated outputs. The server can export these pairs to an external training environment. In that environment, the model's parameters are updated by backpropagation, using an optimization algorithm such as stochastic gradient descent with adaptive learning rates. The model thus gradually adapts to the style and specificity required for merchandise descriptions.

Although training may occur outside the server, the server controls which prompts and corrections become part of the fine-tuning corpus. The server may apply selection rules, for example requiring a minimum edit distance between the generated text and the corrected text to identify beneficial training examples. This selective integration of corrections into the fine-tuning data leads to a technical effect: the model converges faster to a domain-appropriate style and reduces resource consumption during subsequent inference because fewer retries or extensive manual edits are needed.

### 8. Management Screen and Correction Workflow

The server provides a management screen via the terminal. The management screen displays generated texts in association with the corresponding merchandise item. The terminal renders editable text fields that contain the generated product description and advertising short texts. The user reviews the generated texts and inputs corrections and additional details.

The server receives correction information from the terminal and applies the corrections to the generated-text record in the data set. The server may compute a diff between the original generated text and the corrected text and store the diff as metadata. This diff is useful for later analysis and for constructing training examples for further fine-tuning of the generative AI model.

By structurally managing generated texts and corrections in the data set, the server reduces the need for manual copying and pasting between applications, minimizes synchronization errors between multiple versions of product information, and improves the reliability of the stored content. This structured correction workflow contributes to the overall improvement of the computer system by reducing inconsistent state transitions and by enabling efficient retrieval and auditing of text versions.

### 9. Publication State Management and Web Provision

The server controls publication states using state information stored per merchandise item. The management screen on the terminal displays an operation element representing the publication state, such as a toggle or a button. When the user operates this element, the terminal sends updated state information to the server.

The server updates the publication state in the data set and triggers any required downstream processing, such as updating search indexes or clearing caches. When the publication state is set to “published,” the server makes the merchandise information, including images, structured attributes, and corrected texts, available through the web provision interface. The server may produce pre-rendered markup or structured data for consumption by external systems. This approach reduces the computational load at request time by avoiding repeated recomputation of derived representations, thus improving response time and scalability.

### 10. Technical Effects and Improvement of Computer Technology

The server improves computer technology in several ways beyond merely automating human text authoring:
The server uses a structured data set that binds images, attributes, prompt sentences, and generated texts in a normalized form. This design reduces redundancy, optimizes database access patterns, and enhances caching efficiency. As a result, the server can serve management-screen and storefront requests with fewer disk I/O operations and reduced latency.
The server constructs prompt sentences automatically from feature terms extracted from structured attribute information and image metadata. This method reduces computational overhead at the generative AI model stage by providing concise and consistent input sequences. The model, in turn, requires fewer tokens to represent essential information, which reduces inference time and memory usage per request.
The server uses a feedback loop where user-corrected texts are stored in association with their prompts and original outputs. This structural linkage allows targeted fine-tuning of the generative AI model. As the model becomes more aligned with the target domain, the rate of necessary manual corrections and retries decreases, which directly reduces processor load and network traffic associated with repeated calls to the generative AI model.
The server uses non-conventional rules and workflows different from human ad-hoc writing. The server applies deterministic mapping rules from structured attributes to feature terms, combined with templates selected by product category or usage scenario. This rule-guided prompt construction is optimized for the transformer architecture's attention mechanism, leading to more stable and accurate outputs than free-form human prompts. The causal link is that the structured prompts align internal attention heads toward specification tokens, which reduces the probability of generating inconsistent values.
The server implements publication-state control tightly integrated with generated-text management. This integration enables atomic updates to text and state within the same transaction in the data set, avoiding split-brain conditions where public-facing data and internal management data diverge. The result is improved reliability and reduced need for costly reconciliation operations.
The server performs image normalization (format, resolution, color space) at ingestion time, which reduces the variety of image types that downstream modules must handle. This normalization allows the server to simplify image-serving logic and leverage hardware acceleration such as GPU-based image pipelines or CDN edge caching. The technical effect is improved throughput and reduced CPU utilization during peak access times.

### 11. Alternative Embodiments and Variations

In another embodiment, the server incorporates additional model-side features, such as conditioning the generative AI model on embedding vectors computed from merchandise images. The server may compute visual feature vectors using a convolutional neural network or a vision transformer, then concatenate these vectors with token embeddings derived from the prompt sentence. This multi-modal input can further improve the alignment between the product's actual appearance and the generated text.

In another embodiment, the server supports multiple language variants. The prompt sentence includes explicit language instructions, and the data set stores language codes for each generated text. The server can then perform caching based on language and category, reducing repeated model calls for similar products across markets.

In yet another embodiment, the server adjusts the generative AI model's parameters or decoding strategy based on merchandise category or attribute ranges. For high-value items, the server may reduce temperature and increase maximum token counts to generate more conservative and detailed descriptions. This policy-based control is implemented as a rule engine that maps attribute conditions to model configuration parameters, providing a technical means for systematically controlling generation behavior.

The server may also implement local pre-filtering of attribute information for privacy or compliance purposes before constructing a prompt sentence. Sensitive attributes can be removed or obfuscated according to predefined rules, thereby ensuring that the generative AI model does not receive data that should not be processed externally. This design contributes to the secure operation of the computer system by reducing unintended data exposure in network communications.

Through these embodiments, the server, the terminal, and the user cooperate in a technically structured workflow that includes acquisition and normalization of multimedia data, rule-based prompt sentence construction, transformer-based text generation, structured correction and versioning, and integrated publication state control. This arrangement improves the computational efficiency, reliability, and scalability of merchandise-information management, and thereby improves the functioning of the computer system itself.

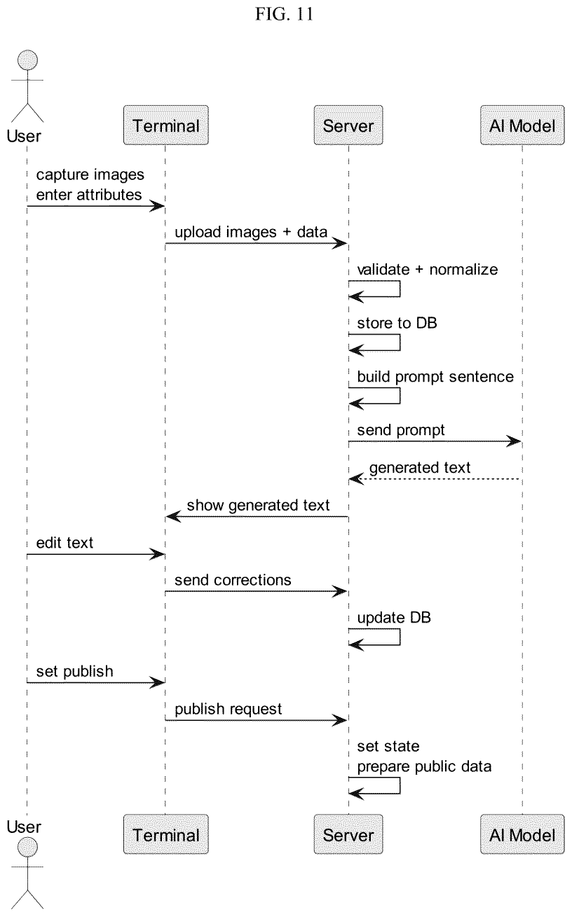

The following describes the processing flow using FIG. 11.

### Step 1

User captures merchandise images using an imaging device such as a digital camera or a smartphone.

Input: A physical merchandise item placed under specified imaging conditions (angles, distance, lighting).

Output: One or more digital merchandise images stored in the local storage of the imaging device.

User adjusts lighting and background to minimize shadows and reflections, positions the merchandise item at a prescribed angle (for example, 45 degrees from the front), and captures multiple images according to a predetermined shooting plan. User saves the captured images in formats such as JPEG or PNG on the device's internal memory or an attached storage medium.

### Step 2

Terminal prepares and selects image files and attribute information for upload.

Input: Digital merchandise images stored locally and merchandise attributes known to the user (for example, material, color, dimension, price).

Output: A set of selected image file references and text fields ready for transmission to the server.

Terminal executes a browser or client application and displays an upload form. User operates the terminal to select image files via a file selection dialog and to input attribute information into structured fields. Terminal temporarily stores the selected file paths and entered attribute values in an in-memory data structure such as a form object.

### Step 3

Terminal transmits the upload request containing merchandise images and attribute information to the server.

Input: Selected image file paths and structured attribute fields from the upload form.

Output: An HTTP request including binary image data and encoded attribute information, sent to the server over a communication network.

Terminal encodes the images and attribute fields into a multipart/form-data or equivalent message, attaches metadata such as content type and filename, and sends an HTTPS POST request to an upload endpoint on the server. Terminal records upload progress and, optionally, displays a progress bar based on bytes transferred.

### Step 4

Server receives and validates the uploaded merchandise images and attribute information.

Input: An HTTP request containing image binary streams and attribute fields from the terminal.

Output: Parsed and validated image objects and attribute records in server memory.

Server parses the multipart payload to separate each image and attribute field, checks that required fields (for example, title, price, material) are present, and verifies that each image is in an acceptable format (for example, JPEG or PNG) and within size limits. Server performs data-type checks (for example, numeric ranges for price and dimensions). If validation passes, server retains the parsed data in working memory; otherwise, server generates an error response.

### Step 5:

Server performs image processing and normalization on the merchandise images.

Input: Validated merchandise image data in original formats and resolutions.

Output: Normalized image files in standardized formats and resolutions, along with updated image metadata.

Server invokes image processing software to perform operations such as format conversion to a standard JPEG format, resizing to preset resolutions (for example, 1024×1024 and 256×256 pixels), and optional color space normalization. Server computes and records metadata such as width, height, file size, and, optionally, a simple color histogram. Server writes the normalized images to a storage location (for example, a file system directory or object storage) and stores references (paths or URIs) in memory.

### Step 6

Server stores merchandise data and image references in a structured data set.

Input: Validated attribute information and references to normalized merchandise images.

Output: Database records associating merchandise identifiers with attributes and image references.

Server generates a unique merchandise identifier and constructs database records including attribute fields, image references, and initial status flags (for example, “draft” and “not published”). Server inserts these records into tables or collections in a database system. Server returns an acknowledgment containing the merchandise identifier to the terminal if needed.

### Step 7

Server extracts feature terms and numerical values from the stored attribute information and image metadata.

Input: Database records for a specific merchandise identifier containing attributes and image metadata.

Output: A set of feature terms and numerical values representing characteristics of the merchandise item.

Server retrieves the record, then applies parsing and mapping rules: for example, it extracts a material string (“genuine leather”), a color string (“red”), numeric dimensions (for example, 30, 20, 10), and a price value (for example, 18000). Server may also compute a dominant color from the image histogram. Server stores these extracted values in a transient feature-term structure in memory, which serves as the basis for prompt construction.

### Step 8

Server constructs a prompt sentence for the generative AI model using a sentence template.

Input: Feature-term structure containing material, color, dimensions, price, classification, and usage-scene indicators.

Output: A prompt sentence string for generating a product description and, optionally, a prompt sentence string for generating advertising short texts.

Server selects a template based on classification or usage scene (for example, a “bag” template vs. a “shoes” template) and inserts feature terms into placeholder positions. Server concatenates fixed phrases and feature terms to form a coherent instruction. For example, server may generate:

“Generate a detailed product description for a red leather handbag. Material: genuine leather. Size: 30 cm×20 cm×10 cm. Price: 18,000 yen. Describe the design, quality, and recommended usage situations in natural, appealing language.”

For advertising text, server may generate:

“Create three short advertising copy lines for an online advertisement promoting a red leather handbag made of genuine leather, highlighting elegance and durability.”

Server stores these prompt sentences in memory and optionally writes them to the database as part of the merchandise record.

### Step 9

Server sends the prompt sentence to the generative AI model and requests generated text.

Input: Prompt sentence string(s) and configuration parameters (for example, model identifier, temperature, maximum output tokens).

Output: A request message transmitted to the generative AI model and a pending inference state on the server.

Server packages the prompt sentence and configuration parameters into a structured payload, such as a JSON body, and sends an HTTPS request to an AI model endpoint. Server logs the request metadata (for example, merchandise identifier, timestamp, template ID) and waits for a response, using a timeout and retry policy if needed.

### Step 10

Server receives generated text from the generative AI model.

Input: HTTP response from the AI endpoint containing generated token sequences.

Output: One or more generated texts decoded into character strings.

Server parses the response payload to extract the token sequence or textual content for the product description and advertising short texts. Server decodes tokens to characters if needed, applies basic post-processing such as trimming whitespace or removing control characters, and validates length and language. The result is a set of generated text strings aligned with the initial prompt sentence.

### Step 11

Server stores the generated text in association with the merchandise item.

Input: Generated product description and advertising short text strings and the merchandise identifier.

Output: Updated database records containing generated texts linked to the merchandise item.

Server updates the generated-text portion of the merchandise record, writing the raw generated description and advertising texts into designated fields. Server also stores a status indicator such as “AI-generated, not yet reviewed” and records timestamps for traceability. This establishes a persistent link between the prompt sentence, the generated text, and the merchandise item in the data set.

### Step 12

Server provides the generated text to the terminal via a management screen interface.

Input: Request from the terminal to display or edit merchandise information, including a merchandise identifier.

Output: Response containing generated text, attributes, and image references formatted for UI rendering.

Server retrieves the merchandise record, including images, attributes, and generated texts. Server constructs a response object (for example, HTML or structured data) that includes the generated product description and advertising short texts in editable fields, along with references to associated images. Server sends this response to the terminal.

### Step 13

Terminal displays the generated text and related merchandise information to the user.

Input: Response data from the server containing generated texts, attributes, and image references.

Output: A rendered management screen showing editable text fields and preview images.

Terminal interprets the response and renders a management screen in the browser or client application. Terminal displays merchandise images, attribute values, and the generated product description and advertising short texts in text fields that allow editing. Terminal indicates that the texts are AI-generated, for example by a label, and prepares to capture any user edits.

### Step 14

User reviews and edits the generated text on the management screen.

Input: Generated product description and advertising short texts displayed on the terminal.

Output: Corrected or augmented text content reflecting user input.

User reads the AI-generated text, compares it with the actual merchandise attributes and desired marketing tone, and edits as needed. User corrects any inaccuracies in specifications (for example, wrong dimension or feature), refines style, and possibly adds store-specific details such as warranty information. User confirms the edited text by saving or submitting the changes on the management screen.

### Step 15

Terminal transmits correction information for the generated text to the server.

Input: User-edited product description and advertising short texts entered in the management screen.

Output: An update request message containing corrected text fields and the merchandise identifier.

Terminal captures the edited content from the management screen and packages the merchandise identifier together with the corrected text fields. Terminal sends an HTTPS POST, PUT, or PATCH request to a server endpoint responsible for text updates. Terminal awaits acknowledgment and may show a success notification when the update is completed.

### Step 16

Server updates the data set with the corrected text and maintains version information.

Input: Update request containing corrected texts and a merchandise identifier.

Output: Database records updated with corrected texts and optional diff or version metadata.

Server retrieves the existing generated texts for comparison and calculates a text difference if required. Server writes the corrected product description and advertising short texts into separate fields (for example, “final_description” and “final_ad_copy”), while optionally preserving the original AI-generated versions. Server updates the status flag to “reviewed” or “ready for publication” and logs the edit operation.

### Step 17

User sets or changes the publication state of the merchandise information.

Input: Management screen showing current publication state and final corrected texts.

Output: A user command indicating a desired publication state change (for example, from “draft” to “published”).

User selects a publication control element on the management screen, such as a toggle or button labeled “Publish,” based on the review of the corrected texts and associated images. User confirms any confirmation dialog presented by the terminal.

### Step 18

Terminal sends updated publication state information to the server.

Input: User command indicating the new publication state and the merchandise identifier.

Output: A state-update request message transmitted to the server.

Terminal encodes the merchandise identifier and the new state (for example, “published” or “unpublished”) in a request body. Terminal submits this request to a publication-state endpoint on the server via HTTPS and waits for a response indicating success or failure.

### Step 19

Server updates publication state and prepares merchandise information for external distribution.

Input: State-update request containing the merchandise identifier and the new publication state.

Output: Updated database state and, if published, prepared publication information accessible via a web provision interface.

Server modifies the publication-state field in the relevant merchandise record and sets or updates a publication timestamp. If the state is set to “published,” server may generate derived representations, such as cached HTML fragments or structured product feeds, and insert or update search index entries. Server ensures that final corrected texts and normalized images are referenced in the public-facing data. This preparation reduces processing required at request time when external clients access the merchandise information.

### Step 20

Server serves published merchandise information to external clients via the web provision interface.

Input: External request for published merchandise information, typically including a merchandise identifier or a search query.

Output: Response containing publication information: images, structured attributes, and final corrected texts.

Server receives a request from an external client, retrieves the relevant merchandise record and any precomputed representations, and returns the content via the web provision interface. This may involve returning HTML pages, structured data for an online store, or API responses to partner systems. By using normalized images, structured attributes, and previously stored final texts, server minimizes real-time computation and provides fast, consistent responses.

### Step 21

User verifies the published merchandise information via the terminal.

Input: Public-facing merchandise page or API output obtained from the server's web provision interface.

Output: User confirmation or decision to perform further edits.

User accesses the public product page using the terminal, inspects images, attributes, and final descriptions and advertising texts as seen by end customers, and confirms correctness. If user detects issues, user returns to the management screen, initiates further edits, and the process from the review and correction steps is repeated as needed.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented systems for registering merchandise items on electronic commerce sites require significant manual intervention at multiple stages, including capturing product images, entering structured product attributes, drafting merchandise descriptions, and composing advertising texts. In typical workflows, a human operator manually photographs a product using arbitrary angles, uploads the images through a generic interface, and then inputs or copies textual information into fixed fields. This fragmented process leads to several technical problems in the underlying information processing system.

First, the system-level utilization of hardware resources such as image input devices, storage devices, and network interfaces is suboptimal. Because image capture is not coordinated with server-side processing, servers often receive redundant or unusable images, resulting in unnecessary data transfer, increased storage consumption, and additional compute load for downstream analysis. This degrades throughput and response time of the overall system.

Second, automatic extraction and structuring of product attributes from images and existing data is limited. Many existing systems treat uploaded images merely as static binary objects and rely on separate, loosely coupled modules or manual work to derive semantic attributes such as category, material, or size. As a result, databases that drive product pages are populated with inconsistent or incomplete product information, which in turn reduces the accuracy and efficiency of subsequent automated processing, such as recommendation engines or search indexing.

Third, the integration of generative AI models in conventional systems is technically shallow. Generative models are often invoked with generic or manually written prompts that do not reflect detailed, machine-extracted product attributes. This results in inconsistent output quality, unpredictable response formats, and additional manual editing to make the generated text suitable for deployment. From a system architecture perspective, the generative AI model is not tightly embedded into the data flow and does not effectively leverage structured, machine-generated context.

Fourth, the generation of multiple candidate product display pages, and the subsequent selection and refinement of such pages, is not well supported by existing platforms at the processing level. Current systems typically generate a single, static template-based page with limited variation. This prevents the system from automatically exploring layout alternatives or adapting content to different promotional strategies, and it forces end users to manually redesign or copy product pages for each variation, which further loads the system with redundant configuration data.

Fifth, the publication pipeline from initial image capture to live product page is not coherently orchestrated in existing architectures. Systems often lack a unified mechanism that, in a single data flow, acquires images, performs recognition, constructs structured attributes, generates prompts, obtains generative text, composes candidate pages, accepts user edits, and finally deploys the approved page to a live electronic commerce environment. This fragmentation leads to complex, error-prone integrations between subsystems, increases latency from product onboarding to publication, and complicates maintenance and scalability.

Accordingly, there is a need for a computer-implemented system that improves the technical functioning of the underlying information processing apparatus by: (i) programmatically generating and enforcing structured imaging plans for merchandise items, (ii) tightly coupling image recognition processing with automatic construction of merchandise attribute information, (iii) systematically generating prompt sentences that encode machine-extracted attributes as keywords for generative AI models, (iv) automatically constructing multiple merchandise display page candidates from both structured and generative outputs, and (v) integrating user-side editing and publication control into a coherent, end-to-end processing pipeline. Such a system can reduce redundant processing, improve data consistency, enhance the quality and predictability of AI-generated content, and increase the efficiency and reliability of electronic commerce site management from a computer technology standpoint.

The specific processing by the specific processing unit 290 of the data processing device 12 in Application Example 1 is realized by the following means.

The present invention provides a server comprising a processor configured to generate, for each merchandise item, an imaging plan including an imaging angle and a number of images as imaging conditions and to transmit an imaging instruction based on the imaging plan to a communication terminal; to receive merchandise images acquired by the communication terminal in accordance with the imaging plan, to store the merchandise images in a storage device, and to perform image recognition processing on the merchandise images so as to extract merchandise attribute information; to construct merchandise information including at least a merchandise name, a price, a material, and a dimension based on the merchandise attribute information and the merchandise images, and to generate a prompt sentence to be input to a generative AI model on the basis of the merchandise information and the merchandise images; to input the prompt sentence to the generative AI model in order to obtain a merchandise description text and an advertising text, and to automatically generate a plurality of merchandise display page candidates by combining the merchandise information, the merchandise images, the merchandise description text, and the advertising text; to transmit the merchandise display page candidates to a user terminal, to update the merchandise display page candidates based on editing operation information received from the user terminal, and to generate a final merchandise display page approved by a user; and to upload the final merchandise display page to an information providing apparatus for publication so that the final merchandise display page is viewable on an electronic commerce site. This enables the underlying computer system to coordinate image capture and server-side processing, to automatically derive structured attributes and optimized prompt sentences from image recognition outputs, to tightly integrate generative AI model responses into multi-variant page construction, and to manage user-driven refinement and publication within a unified, machine-controlled workflow, thereby improving processing efficiency, data consistency, and responsiveness of electronic commerce site management.

The term “system” refers to a combination of at least one server, at least one communication terminal, and associated storage and network resources that cooperate to perform merchandise registration and product page generation for an electronic commerce site.

The term “processor” refers to a hardware-based computation unit, such as a central processing unit or a processing core, configured to execute program instructions that implement the functions described in the claims.

The term “imaging plan” refers to structured imaging conditions for a merchandise item, including at least an imaging angle and a number of images, and optionally including parameters such as resolution, zoom level, or lighting conditions, which are used to control image capture by a communication terminal.

The term “imaging angle” refers to a relative orientation of a merchandise item with respect to an image capturing device, such as a front view, rear view, side view, or detail view, which is specified as part of the imaging plan.

The term “number of images” refers to a quantity of images to be captured for a particular imaging angle or condition, as specified in the imaging plan.

The term “communication terminal” refers to an electronic device having a network communication function and an image capturing function, such as a portable information terminal, a smart device, or a general-purpose computing device equipped with a camera.

The term “merchandise item” refers to a product or a service unit that is intended to be listed, described, and offered on an electronic commerce site.

The term “merchandise image” refers to digital image data obtained by capturing a merchandise item with an image capturing device of the communication terminal in accordance with the imaging plan.

The term “storage device” refers to a physical or virtual data storage resource, such as a disk device, a solid-state memory, or a network-based storage service, configured to store merchandise images, merchandise attribute information, and related data.

The term “image recognition processing” refers to computational processing performed on merchandise images using image analysis techniques, including at least one of pattern recognition, feature extraction, and machine learning-based classification, to detect or infer properties of a merchandise item.

The term “merchandise attribute information” refers to structured data representing characteristics of a merchandise item extracted from merchandise images, including, for example, a category, a color, a size indication, a material indication, or a style indication.

The term “merchandise information” refers to aggregated and structured data about a merchandise item, including at least a merchandise name, a price, a material, and a dimension, and optionally including additional attributes such as color, category, or descriptive tags.

The term “prompt sentence” refers to text data or a structured textual instruction that encodes merchandise information and merchandise attribute information and is supplied as input to a generative AI model to cause the generative AI model to generate merchandise-related text.

The term “generative AI model” refers to a machine learning model, such as a language model, configured to generate natural language text in response to a prompt sentence, based on learned statistical patterns in training data.

The term “merchandise description text” refers to a natural language text describing features, usage, or benefits of a merchandise item, generated by the generative AI model based on the prompt sentence.

The term “advertising text” refers to natural language text intended to promote a merchandise item, including, for example, headlines, taglines, or sales-oriented copy generated by the generative AI model based on the prompt sentence.

The term “merchandise display page candidate” refers to a data structure representing a possible version of a merchandise display page, including at least one layout, one or more merchandise images, merchandise information, and one or more of a merchandise description text and an advertising text.

The term “user terminal” refers to an information processing device operated by a user, such as a personal computer, a portable information terminal, or another communication terminal, used to display merchandise display page candidates and to input editing operations.

The term “editing operation information” refers to data representing user operations applied to a merchandise display page candidate, including at least one of text modification, layout selection, image selection, or price adjustment.

The term “final merchandise display page” refers to a merchandise display page that has been derived from at least one merchandise display page candidate, updated based on editing operation information, and approved by a user for publication.

The term “information providing apparatus” refers to a server or a server cluster configured to store and distribute content for an electronic commerce site, such that uploaded merchandise display pages are accessible over a network.

The term “electronic commerce site” refers to a network-accessible service, such as a web-based service, through which users can browse merchandise information and perform commercial transactions for merchandise items.

The term “attribute terms” refers to words or phrases that express attributes or characteristics of a merchandise item, such as category names, material names, size indicators, or style descriptors, which are derived from merchandise attribute information or merchandise information.

In one embodiment, a server, a terminal, and a user cooperate to implement the claimed system in a concrete computing environment. The server executes program modules on a hardware platform including at least one central processing unit, a main memory, a non-volatile storage device, and a network interface. The server runs an operating system such as a general-purpose server operating system and middleware including a web server and an application server. The terminal includes an imaging device such as a digital camera integrated in a portable information terminal, a processor, a memory, and a wireless or wired communication interface. The user operates the terminal and a user terminal such as a personal computer or another portable information terminal equipped with a browser or a dedicated application.

The server generates and maintains an imaging plan for each merchandise item. The server stores the imaging plan in a relational database as a structured record including fields such as an item identifier, a list of imaging angles, a required number of images for each angle, a required resolution, and optional parameters such as exposure level and zoom ratio. The server uses application logic implemented in a web application framework to retrieve and update the imaging plan and to transmit the imaging plan to the terminal as structured data over a communication protocol such as HTTP or HTTPS.

The terminal uses its camera hardware to capture merchandise images according to the imaging plan. The terminal runs an application implemented using a mobile application framework that accesses the camera through an operating system camera application programming interface. The terminal displays an overlay frame or guide on its display and adjusts the camera parameters such as focus and exposure based on automatic image analysis performed locally on preview frames. The terminal uses algorithms such as histogram analysis for brightness evaluation and gradient-based focus measures to determine when the merchandise item is properly framed and in focus. Once the terminal determines that the conditions satisfy predetermined thresholds, the terminal automatically captures images without requiring manual pressing of a shutter button. This camera control achieves consistent image quality and reduces the number of unusable images, thereby decreasing subsequent network and storage load on the server.

The terminal associates each captured image with metadata including the imaging angle, a capture sequence index, a timestamp, and a session identifier corresponding to the merchandise item. The terminal stores the images temporarily in local storage and transmits the images and the metadata to the server. The terminal may compress the images using an image compression algorithm such as JPEG encoding with a specified quality factor in order to reduce data size while preserving sufficient detail for recognition. This compression decreases transmission time and reduces bandwidth usage, improving overall system throughput.

The server receives the merchandise images and stores them in a storage device such as a file system or an object storage service. The server records metadata including a path or uniform resource identifier of each image, the corresponding imaging angle, and the item identifier in the database. The server then performs image recognition processing on the merchandise images in order to extract merchandise attribute information. The server uses an image processing library to perform pre-processing operations such as resizing, cropping, normalization of pixel values, and background reduction. The server applies a neural network-based image recognition model, for example a convolutional neural network including multiple convolution layers, pooling layers, and fully connected layers.

In one implementation, the server uses an architecture with residual connections and batch normalization layers to stabilize training and inference. The server feeds the pre-processed merchandise images as tensors into the network. The network outputs feature vectors representing the merchandise item and probability distributions over predefined categories such as clothing type, footwear type, and accessories. The server interprets the output probabilities to determine a merchandise category. The server also uses auxiliary output heads of the network to predict additional attributes such as color, sleeve type, and pattern presence. For label or tag recognition, the server applies an optical character recognition model implemented as a convolutional-recurrent neural network that decodes text from regions identified as labels. By using these model structures, the server automatically derives structured attribute information that could not be reliably or efficiently extracted by manual inspection at the scale and speed of automated processing.

The server constructs merchandise attribute information by aggregating recognition results from multiple images associated with the same merchandise item. The server uses algorithms such as majority voting or confidence-weighted averaging across images to determine robust attribute values. For example, if most images indicate a white color and a short-sleeve style, the server records “white” and “short sleeve” as stable attributes. This aggregation reduces the impact of recognition errors in individual frames and improves the reliability of the computed merchandise attribute information, thereby increasing the accuracy of subsequent processing.

The server then constructs merchandise information based on the merchandise attribute information and the merchandise images. The server uses application logic to populate fields such as merchandise name, price, material, and dimension. In some cases, the server may combine default or reference values stored in a product master database with recognized attributes. For example, the server may match a recognized label code to a product template that defines typical material and standard dimensions. The server represents the merchandise information as a structured data object with fields such as name, price, material, size, dimensions, color, category, and descriptive tags.

The server generates a prompt sentence to be input to a generative AI model. The server analyzes attribute terms included in the merchandise attribute information and the merchandise information, and selects such attribute terms as keywords to be embedded in the prompt sentence. The server formats the prompt sentence as natural language text that clearly specifies required outputs and constraints. In one example, the server generates a prompt sentence such as:

“You are assisting in creating product information for an e-commerce site.

Here is the extracted data from image recognition:
Category: T-shirt
Color: White
Detected text on label: ‘100% cotton’, ‘M’
Style: Short sleeve

Based on this data, please:
1. Propose a clear product name.
2. Propose a reasonable price in JPY, assuming mid-range casual wear.
3. Confirm or infer the material and size.
4. Generate a short product description (80-120 words) suitable for an online store.”

The server outputs this prompt sentence to a generative AI model. The generative AI model is implemented as a language model using a neural network architecture such as a transformer. The model includes multiple layers of self-attention and feed-forward sublayers, and parameters (weights) that have been learned through pre-training on large corpora of natural language text. During operation, the server encodes the prompt sentence into token sequences, retrieves embedding vectors from an embedding matrix, and applies the transformer layers to compute contextual representations of the tokens. The model then predicts the next token iteratively to generate a merchandise description text and an advertising text.

The server configures the generative AI model with specific decoding parameters such as temperature, top-k or nucleus sampling thresholds, and maximum output length. By controlling these parameters, the server regulates the variability and determinism of the generated text. The server may instruct the model to output a structured format with explicit markers for fields such as “Product Name,” “Price,” “Material,” and “Size” to facilitate parsing. This structured prompting and decoding process reduces post-processing overhead and avoids ambiguous outputs, thereby improving computational efficiency and data consistency.

In another example, the server generates a prompt sentence for marketing-oriented content generation, such as:

“You are a copywriter for an online fashion store.

Using the following product information:

Category: T-shirt

Name: Classic White Cotton Tee

Price: 2000 JPY

Material: 100% cotton

Size: M

Color: White

Generate:
1 catchy product title (max 60 characters),
1 short tagline (max 25 words),
3 bullet points highlighting comfort, material, and everyday usability.

Use a friendly and casual tone.”

The generative AI model processes this prompt sentence and returns text for a merchandise description and advertising portions such as titles and bullet points. The server parses the output using rule-based parsing logic and, when instructed, applies regular expressions or delimiter-based splitting to extract the individual fields. The server combines the merchandise information, the merchandise images, the merchandise description text, and the advertising text to automatically generate a plurality of merchandise display page candidates. The server uses a template engine to define different layout templates, and fills the templates with the generated content. Each candidate includes references to specific image identifiers, text blocks, and price or purchase components.

The server transmits the merchandise display page candidates to a user terminal via a web interface or a dedicated application interface. The user operates the user terminal to review the candidates. The user may select a layout, modify text, adjust the price, or change images. The user terminal transmits editing operation information back to the server. The server updates the merchandise display page candidates based on the editing operation information and generates a final merchandise display page when the user indicates approval. The server ensures that the final merchandise display page is consistent by re-validating fields such as price and stock identifiers before committing the final version to the publication storage.

The server uploads the final merchandise display page to an information providing apparatus that hosts an electronic commerce site. The server may convert the page into a format required by the electronic commerce platform, such as structured markup or application programming interface payloads. The server triggers cache invalidation or cache updating at a content distribution layer so that the new merchandise display page becomes promptly accessible to end-users. By controlling the entire pipeline from image capture planning to publication, the server reduces latency and avoids redundant or conflicting content updates.

The described configuration yields several technical effects beyond mere automation of human tasks. First, the coordinated imaging plan generated by the server and enforced by the terminal leads to standardized image capture, which improves the accuracy of image recognition processing and reduces the number of images that must be analyzed and stored. This yields improvements in processing speed and storage efficiency. Second, the tight integration between image recognition and prompt sentence generation ensures that the generative AI model receives detailed, machine-derived attribute terms, leading to more accurate and consistent text outputs. This reduces the need for manual post-editing, minimizes re-processing, and enhances throughput.

Third, the specific neural network structures and training methods used for image recognition and language generation contribute to technical improvements. The convolutional neural networks may be trained using supervised learning with labeled datasets of merchandise images, employing loss functions such as cross-entropy loss for classification and connectionist temporal classification loss for text recognition. The training procedure includes weight updates by gradient descent or adaptive optimization algorithms, and data augmentation techniques such as random cropping, rotation, and color jittering to improve generalization. These details lead to recognition models that operate robustly under varying imaging conditions, thereby reducing classification errors and making downstream prompt generation more reliable.

Fourth, the transformer-based generative AI model is trained using unsupervised or self-supervised learning objectives such as next-token prediction on large text corpora. Fine-tuning may be performed using domain-specific corpora related to merchandise descriptions and advertising texts. By tailoring the model in this way and combining it with structured prompts built from machine-extracted attributes, the server obtains outputs that are both contextually appropriate and structurally regular. This configuration improves computational efficiency because the number of iterations of user-driven correction and re-generation is reduced.

Fifth, the server implements data structures and processing flows that specifically reduce communication and computation overhead. For example, the server may cache intermediate attribute extraction results and reuse them when regenerating prompt sentences or layout variants, instead of re-running image recognition for each content generation request. The server may also compress prompt sentences by referencing attribute codes instead of full text descriptions when calling internal or external generative AI services, thereby reducing payload sizes on network calls.

The system described above is not limited to a single embodiment. In another embodiment, the server may employ a different type of neural network architecture for image recognition, such as a vision transformer that processes images as patch sequences. In another variant, the terminal may perform part of the image recognition processing locally, for example, to detect whether the merchandise item is within the frame before sending images, which further reduces network traffic and server load. In yet another embodiment, the generative AI model may be deployed on a separate inference server, and the main server may schedule requests and aggregate outputs from multiple models with different parameter sizes or specialties, such as one model focusing on technical descriptions and another focusing on promotional copy.

In each of these embodiments, the server, the terminal, and the user cooperate to realize a system in which the computer-based pipeline—from imaging plan generation, image capture, and attribute extraction to prompt sentence generation, generative AI model invocation, candidate page construction, user editing, and final publication—produces technical improvements in processing speed, output quality, and resource utilization of the underlying computing infrastructure.

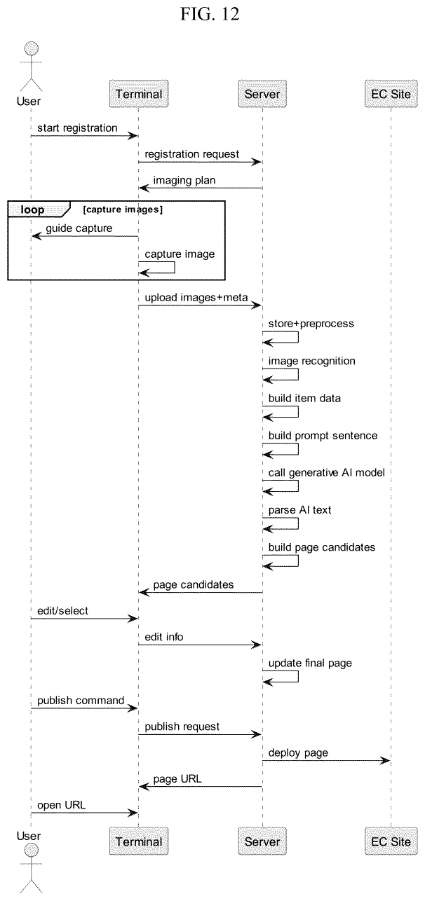

The following describes the processing flow using FIG. 12.

### Step 1

The user prepares a merchandise item for registration. The user physically places the merchandise item in front of the terminal's camera and launches an application on the terminal to start a new merchandise registration session.

Input: a physical merchandise item, a user's instruction to start registration.

Output: a registration request including at least a merchandise session identifier and an intended merchandise category, transmitted from the terminal to the server.

### Step 2

The server generates an imaging plan for the merchandise item. The server receives the registration request, retrieves default imaging conditions for the indicated category from a database, and constructs an imaging plan that includes specific imaging angles, a required number of images for each angle, and target resolution parameters. The server serializes this imaging plan as structured data and sends it to the terminal.

Input: the registration request including category information and session identifier.

Output: an imaging plan object including imaging angles, image counts, and resolution constraints, transmitted to the terminal.

### Step 3

The terminal guides the user and controls the camera according to the imaging plan. The terminal displays step-by-step instructions, activates the camera using a camera API, and overlays framing guides corresponding to each imaging angle. The terminal continuously analyzes preview frames to evaluate brightness and focus using image statistics such as histograms and gradient-based focus measures, and automatically triggers image capture when evaluation values meet predetermined thresholds.

Input: the imaging plan received from the server and live camera preview frames.

Output: a plurality of captured merchandise images tagged with metadata including imaging angle, sequence index, and session identifier, stored in terminal memory.

### Step 4

The terminal uploads captured merchandise images and metadata to the server. The terminal optionally compresses each image using an image compression algorithm to reduce file size, packages the images and associated metadata into a network request, and transmits the request via a communication interface. The terminal may handle retransmission in case of temporary network failure.

Input: captured merchandise images and metadata stored on the terminal.

Output: an upload request containing image binary data and metadata, transmitted to the server.

### Step 5

The server receives, validates, and stores the merchandise images. The server checks file formats, sizes, and the number of images against the imaging plan. The server writes image data to a storage device and records corresponding metadata, including storage locations and imaging angles, in a database.

Input: the upload request containing images and metadata from the terminal.

Output: stored merchandise images in a storage device and associated records in a database, ready for image recognition processing.

### Step 6

The server performs pre-processing on the stored images. The server loads each image, resizes it to a target resolution, normalizes pixel intensity values, and optionally performs background reduction to emphasize the merchandise item. The server converts each processed image into a numerical tensor representation suitable for input to an image recognition model.

Input: stored merchandise images retrieved from storage.

Output: pre-processed image tensors and associated metadata, passed to an image recognition module.

### Step 7

The server executes image recognition to extract merchandise attribute information. The server feeds the pre-processed image tensors into a trained neural network, such as a convolutional neural network or a vision transformer, and obtains output vectors representing class probabilities and attribute predictions. The server interprets the outputs to determine category, color, and style attributes and applies an optical character recognition component to detect and decode textual information on labels.

Input: pre-processed image tensors and imaging metadata.

Output: preliminary merchandise attribute information, including predicted category, color, style, and label text, for each image.

### Step 8

The server aggregates attribute information across multiple images for the same merchandise session. The server groups attribute outputs by session identifier and applies aggregation logic, such as majority voting for discrete categories and confidence-weighted averaging for continuous attributes, to obtain unified attribute values for the merchandise item.

Input: preliminary merchandise attribute information for all images of a session.

Output: consolidated merchandise attribute information, including stable category, color, style, and label-derived values for the merchandise item.

### Step 9

The server constructs merchandise information from the consolidated attributes and any reference data. The server populates fields such as merchandise name, price, material, and dimension based on the consolidated attributes and, if available, reference tables or templates identified by label codes. The server structures this information into a merchandise information object containing fields like name, price, material, size, dimensions, and category.

Input: consolidated merchandise attribute information and optional reference database entries.

Output: a merchandise information object with structured fields describing the merchandise item.

### Step 10

The server generates a prompt sentence for a generative AI model based on the merchandise information and attribute terms. The server selects key attribute terms such as category, color, material, and size and embeds them into a natural language instruction that specifies the desired outputs from the generative AI model, including formatting and length constraints.

Input: the merchandise information object and the merchandise attribute information.

Output: a prompt sentence in natural language that encodes merchandise details and generation requirements.

### Step 11

The server inputs the prompt sentence to the generative AI model and receives generated text. The server tokenizes the prompt sentence, sends it to a language model implemented as a transformer network, and decodes the model's output tokens into text. The server requests specific content elements such as a merchandise description text and an advertising text in the form of titles, taglines, or bullet points.

Input: the prompt sentence provided to the generative AI model.

Output: generated text outputs including a merchandise description text and an advertising text, received from the generative AI model.

### Step 12

The server parses and validates the generated text. The server analyzes the generated text to extract designated sections, using delimiters or pattern matching, and checks constraints such as length limits and required inclusion of certain attributes or keywords. The server corrects or flags outputs that do not satisfy validation rules and may request re-generation under adjusted parameters if necessary.

Input: generated text outputs from the generative AI model.

Output: validated and structured generated content segments, including a merchandise description and advertising components.

### Step 13

The server composes multiple merchandise display page candidates. The server selects layout templates from a template library and fills each template with the merchandise information, merchandise images, and the validated generated text. The server constructs different combinations of layouts and text variants to produce multiple page candidates.

Input: merchandise information, stored merchandise images, and validated generated text.

Output: a set of merchandise display page candidate objects, each including layout, images, and text content.

### Step 14

The server transmits the merchandise display page candidates to the user terminal. The server formats the candidate objects into a representation suitable for rendering, such as structured markup or structured data, and sends them through a network interface. The server may also include identifiers for each candidate to track subsequent editing operations.

Input: merchandise display page candidate objects generated by the server.

Output: a response containing the page candidates and identifiers, transmitted to the user terminal.

### Step 15

The user reviews and edits the merchandise display page candidates. The user terminal displays each candidate, including images, merchandise information, and generated text. The user may select a candidate, edit text fields, adjust prices, rearrange images, or change layout choices through the interface. The user terminal collects these changes as editing operation information.

Input: displayed merchandise display page candidates on the user terminal.

Output: editing operation information describing user modifications and selected candidate, transmitted from the user terminal to the server.

### Step 16

The server updates the selected merchandise display page candidate based on the editing operation information. The server applies the changes to the corresponding candidate object, updating fields such as description text, price, and image selections. The server recalculates any derived fields if necessary, such as discount values or stock-keeping identifiers linked to price changes.

Input: editing operation information associated with a candidate identifier.

Output: an updated merchandise display page object representing a user-approved final version, stored on the server.

### Step 17

The user approves the final merchandise display page for publication. The user views the updated page on the user terminal and issues a publication instruction through a management screen, for example by pressing a publish button. The user terminal sends a publication command referencing the finalized page to the server.

Input: the updated merchandise display page presented on the user terminal and a user's publication instruction.

Output: a publication request including the identifier of the final merchandise display page, transmitted to the server.

### Step 18

The server publishes the final merchandise display page to an information providing apparatus. The server converts the final page object into the required deployment format for the electronic commerce site, registers or updates product records in a catalog system, uploads associated images if necessary, and triggers cache updates so that the page becomes accessible.

Input: the final merchandise display page object and the publication request.

Output: a deployed merchandise display page on the electronic commerce site, and a publication result including a page URL returned to the user terminal.

### Step 19

The user verifies the published merchandise display page. The user accesses the provided URL using the user terminal, checks that images, descriptions, and prices are correct, and optionally performs a test interaction such as adding the item to a cart. If discrepancies are found, the user can return to the editing process by sending a revision instruction from the user terminal.

Input: the published merchandise display page accessible via a URL.

Output: a verification result from the user, which may be an implicit approval (no further action) or a new revision request sent to the server.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional systems for generating merchandise pages in electronic commerce environments rely heavily on manual authoring of product descriptions, advertising copy, and page layouts by human operators. In many implementations, a server simply stores product images and basic attributes and then presents generic templates that must be filled and adjusted by the user. As a result, the quality of the generated pages depends on the individual skill of the operator, and the time and labor required to produce consistent, high-quality content increase substantially as the number of merchandise objects grows.

Furthermore, existing approaches that invoke a generative AI model often do so in a naive manner, for example by sending raw product text to the model without systematic extraction of structured classification information and feature information, and without coordinated template selection. Such approaches tend to produce unstable output quality, redundant or incomplete feature coverage, and content that does not match the layout or component structure of the final page. In addition, many systems treat the generative AI model as an isolated text generator, rather than as an integrated part of a data processing pipeline that begins with multi-modal analysis of both image information and attribute information.

From a computer technology standpoint, there is insufficient optimization of the end-to-end processing pipeline within the server. Specifically, there is no well-defined mechanism for the processor to (i) analyze stored image information and attribute information, (ii) derive consistent classification information and feature information, (iii) automatically select an appropriate screen template from multiple registered templates, and (iv) construct a structured prompt sentence that aligns the generative AI model output with the selected template. As a result, computing resources are not used efficiently, and repeated manual corrections by users on terminal devices lead to unnecessary network traffic and storage operations, degrading system-level performance and scalability.

In addition, conventional systems do not adequately integrate the user's confirmation and correction operations into the server-side generation logic. Updated information from the terminal is often handled as ad hoc edits to static content, rather than as structured update information that can refine prompt generation, model interaction, and template-based regeneration. This lack of integration prevents the system from systematically improving the quality and consistency of the generated display page information and from reducing the computational cost of subsequent updates.

Accordingly, there is a need for a computer-implemented technique that improves how a server processes merchandise-related image information and attribute information, interacts with a generative AI model via carefully constructed prompt sentences, and automatically generates and updates display page information in coordination with template selection and user feedback. Such a technique should improve the efficiency, consistency, and quality of content generation while reducing manual workload and unnecessary computational overhead, thereby providing a concrete improvement in the functioning of the computer system itself.

The specific processing by the specific processing unit 290 of the data processing device 12 in Example 2 is realized by the following means.

The present invention provides a server comprising a processor and a storage unit, the processor being configured to acquire, for each merchandise object, image information under a plurality of imaging conditions and to store the acquired image information together with attribute information in the storage unit; to perform character-string analysis processing and image analysis processing on the stored image information and attribute information so as to extract classification information and feature information of the merchandise object in a structured form; to select, on the basis of the extracted classification information and feature information, a screen template suitable for the merchandise object from among a plurality of screen templates whose screen configuration information is registered in the storage unit; to generate, in correspondence with the selected screen template, a prompt sentence including at least the classification information, the feature information, and the attribute information, and to input the prompt sentence to a generative AI model so as to cause the generative AI model to generate explanatory character information and appeal character information that are aligned with the selected screen template; to apply the explanatory character information and the appeal character information generated by the generative AI model, together with the image information and the attribute information, to the selected screen template so as to automatically generate display page information relating to the merchandise object; to transmit the generated display page information to a terminal device, to receive update information based on confirmation and correction operations performed at the terminal device, and to update the display page information in accordance with the update information; and to respond to a publication operation performed via a management screen for the updated display page information by transmitting the updated display page information to a delivery information processing device for external provision. This enables the server to implement an integrated, computer-optimized pipeline that transforms raw image information and attribute information into structured, template-consistent display page information via prompt-based interaction with a generative AI model, thereby improving the efficiency, consistency, and quality of merchandise page generation and reducing manual intervention while enhancing the overall performance and scalability of the computer system.

The term “processor” refers to a hardware or virtual computation unit, such as a central processing unit or a processing core, that executes machine-readable instructions to perform data acquisition, analysis, generation, and communication operations described in this specification.

The term “storage unit” refers to a hardware-based or virtual data retention resource, such as a memory device or a storage device, configured to store image information, attribute information, templates, generated text, and control information used by the processor.

The term “merchandise object” refers to any item or service that is intended to be presented or sold through an electronic information presentation system, including but not limited to physical goods, digital goods, and service offerings.

The term “image information” refers to digital data representing one or more images of a merchandise object, captured or obtained under one or more imaging conditions, and stored in a format suitable for processing and analysis by the processor.

The term “imaging condition” refers to a parameter or combination of parameters under which the image information is acquired, including at least one of camera position, angle, distance, lighting, background, or resolution.

The term “attribute information” refers to structured or semi-structured data describing properties of a merchandise object, including but not limited to name, category, price, specifications, textual descriptions, and other metadata.

The term “character-string analysis processing” refers to a computational procedure in which the processor analyzes textual data, including attribute information, to extract linguistic elements, keywords, categories, or other structured information.

The term “image analysis processing” refers to a computational procedure in which the processor analyzes image information to detect or infer visual features, categories, or attributes associated with a merchandise object.

The term “classification information” refers to structured data indicating one or more categories or classes to which a merchandise object belongs, derived from character-string analysis processing, image analysis processing, or a combination of both.

The term “feature information” refers to structured data representing characteristic properties, functions, or advantages of a merchandise object, extracted from image information, attribute information, or both.

The term “screen template” refers to a predefined data structure or layout definition that specifies arrangement, style, and types of components for generating display page information related to a merchandise object.

The term “screen configuration information” refers to data describing structural aspects of a screen template, including component positions, text regions, image regions, and formatting rules used to render a display page.

The term “template storage unit” refers to a storage resource configured to store multiple screen templates and associated screen configuration information that are selectable by the processor.

The term “prompt sentence” refers to a machine-readable instruction sequence or text input that is constructed by the processor and provided to a generative AI model to control or guide the content, style, and structure of generated output.

The term “generative AI model” refers to a machine learning model configured to generate text or other content based on input data, such as a prompt sentence, using statistical, neural, or other learning-based techniques.

The term “explanatory character information” refers to generated textual content that describes features, functions, or characteristics of a merchandise object in a descriptive or explanatory manner.

The term “appeal character information” refers to generated textual content intended to promote, advertise, or emphasize advantages of a merchandise object, including slogans, taglines, or persuasive phrases.

The term “display page information” refers to structured data representing a presentation page for a merchandise object, including layout information, textual content, image references, and formatting data suitable for rendering on a display device.

The term “terminal device” refers to any user-operated computing apparatus, such as a personal computer, mobile device, or tablet, that can communicate with the server, display display page information, and accept user input.

The term “update information” refers to data representing modifications to display page information, the modifications being based on confirmation or correction operations performed by a user through a terminal device.

The term “management screen” refers to a user interface presented on a terminal device that allows a user to perform management operations, including confirmation, correction, publication setting, and publication instruction for display page information.

The term “publication operation” refers to a user-initiated command or sequence of commands, received via the management screen, that instructs the server to set corresponding display page information to a state in which it is accessible to external destinations.

The term “delivery information processing device” refers to a computing resource or server that receives display page information from the server and provides the display page information to external destinations, such as client systems or network users.

In one embodiment, a server, a plurality of terminal devices, and a delivery information processing device are interconnected via a communication network such as the Internet. The server includes at least one processor, a main memory, a non-volatile storage device, and a network interface. The processor is implemented by a general-purpose central processing unit or a combination of a central processing unit and a graphics processing unit. The main memory is implemented by a semiconductor memory, and the non-volatile storage device is implemented by a magnetic disk device, a solid-state drive, or a non-transitory storage medium of equivalent function.

The server executes an operating system and application software implemented, for example, by a web application framework such as a script-based server framework or a virtual machine-based framework. The server further executes a plurality of software modules including a data acquisition module, an image analysis module, a text analysis module, a template selection module, a prompt generation module, a generative AI interface module, a post-processing module, a page generation module, and a management interface module. The modules are stored in the non-volatile storage device as executable instructions and are loaded into the main memory when executed by the processor.

The server stores, in the non-volatile storage device, an information storage unit that holds product-related records. Each record includes attribute information fields such as an identifier, a category field, a price field, a textual description field, and a metadata field, and also holds one or more references to image information files. The server further stores a template storage unit that holds a plurality of screen templates. Each screen template includes screen configuration information defining component regions, priority rules, and display constraints. The screen configuration information is represented as a structured data configuration, for example as a tree or graph structure specifying, for each node, a component type, a size, a position, and a binding to a semantic role such as “headline,” “feature list,” or “hero image.”

The server additionally stores a generative AI configuration dataset, including model identifiers, parameter ranges, and predefined prompt patterns. The generative AI model is implemented, in one embodiment, as a transformer-based neural network trained to generate natural-language text. The neural network includes a plurality of attention layers, feed-forward layers, and embedding layers, and is trained on a corpus of product descriptions and advertising texts. The training process uses a loss function such as cross-entropy loss between predicted token distributions and ground-truth token sequences, and the server or an associated training environment updates the model parameters using a gradient-based optimization algorithm such as stochastic gradient descent or Adam. During training, the system applies data augmentation techniques such as synonym replacement, sentence reordering within a constrained range, and random masking of description segments, in order to improve robustness and generalization of the generative AI model.

The server uses the image analysis module to process image information associated with each merchandise object. The image analysis module is implemented by a convolutional neural network that has a plurality of convolutional layers, pooling layers, and fully connected layers, trained to recognize object categories and visual attributes. The server converts each image into a normalized tensor representation, applies convolutional filters, and obtains feature maps. The server then aggregates the feature maps into a fixed-length feature vector representing the visual characteristics of the merchandise object. From this feature vector, the server derives classification information such as “electronics” or “apparel,” and feature information such as “large display,” “multiple cameras,” or “compact form factor.” By executing this processing on the processor and, when available, offloading matrix operations to the graphics processing unit, the server improves processing speed and reduces latency in image classification relative to purely manual image labeling.

The server uses the text analysis module to process attribute information such as free-text descriptions, specification lists, and user-provided tags. The text analysis module tokenizes the text, maps tokens to vector embeddings, and applies a neural classifier or statistical model to determine classification information and feature information. The server aligns the classification information derived from image analysis with that derived from text analysis, and the server resolves conflicts by applying predefined rules. For example, when the image analysis indicates “smartphone” and the text analysis indicates “mobile device,” the server normalizes both into a unified classification “smartphone” stored in a category field. The server further extracts feature information such as “high-resolution camera” or “long battery life” and stores the extracted feature information in a structured metadata field. This structured representation enables the server to perform efficient queries and to reduce repeated manual annotation operations.

The server uses the template selection module to select an appropriate screen template from the template storage unit. The server compares the classification information and feature information of a merchandise object with template metadata stored for each screen template. The server employs a rule set that may include decision-tree-like conditions such as “if category is electronics and feature set includes camera, use template group A; if category is apparel and feature set includes color variations, use template group B.” The server also computes a similarity score between the feature vector of the merchandise object and a template profile vector associated with each screen template. The template profile vector is constructed by averaging feature embeddings of a set of representative products that have been historically assigned to the template. The server selects the screen template whose profile vector has the highest similarity score to the merchandise object feature vector, thereby optimizing template selection and improving alignment between content and layout.

The server uses the prompt generation module to construct a prompt sentence for the generative AI model. The server retrieves classification information, feature information, attribute information, and template-specific requirements from the storage units. The server then assembles a text sequence that specifies, in a deterministic format, the product name, category, main features, target audience, desired tone, and length constraints. In one example, the server generates a prompt sentence as follows:

“Write a persuasive product description in English for an online store. Product name: ‘Latest Model X'. Category: smartphone, electronics. Key features: high-resolution camera, long battery life, 6.5-inch display, wireless connectivity. Target audience: general consumers who enjoy photography and social media. Tone: friendly and easy to understand. Length: about 150-200 words. Emphasize camera quality and battery duration.”

In another example, the server generates a prompt sentence for a shorter advertisement phrase:

“Generate a short and catchy tagline in English (under 12 words) for ‘Latest Model X', a smartphone with a high-resolution camera and long battery life.”

The server constructs these prompt sentences in a structured manner, including explicit delimiters and ordering rules, so that the generative AI model receives consistent context. This structured construction enables the generative AI model to use the provided classification information and feature information efficiently, thereby improving accuracy and reducing variance in the generated outputs.

The server uses the generative AI interface module to transmit the prompt sentence to the generative AI model. When the generative AI model runs on a remote computing resource, the server transmits the prompt sentence via a network interface using a secure communication protocol and receives a response including generated character sequences. When the generative AI model runs locally, the server invokes model inference using a neural network inference library, loads the trained model parameters from the storage unit, and computes output token sequences by iteratively applying the transformer architecture's attention and feed-forward layers. The server controls generation parameters such as temperature, top-k or top-p sampling thresholds, and maximum token length, according to rules stored in the generative AI configuration dataset. By adjusting these parameters in response to template type and product category, the server reduces unnecessary token generation and thereby decreases computational workload and response time.

The server uses the post-processing module to analyze the generated explanatory character information and appeal character information. The server segments the generated text into a headline, one or more paragraphs, and one or more bullet-like feature lines. The server applies rule-based filters to remove or modify phrases that do not match brand guidelines or violate length limits. The server can also invoke a grammar-check module that applies a language model or a rule-based checker to detect and correct grammatical errors. This post-processing improves the quality and readability of the generated content and reduces the number of user corrections needed at the terminal devices, thus decreasing network traffic and storage access operations for subsequent updates.

The server uses the page generation module to combine the processed explanatory character information, the appeal character information, the image information, and the attribute information with the selected screen template. The server fills placeholders in the screen template with the corresponding data items and generates display page information in a markup language format together with layout metadata. The display page information includes resource references to image files, font definitions, and style information. The server stores the generated display page information in association with the merchandise object record and can deliver this display page information to multiple terminal devices.

The terminal is implemented by a user-operated computing device such as a personal computer, a tablet device, or a mobile communication device. The terminal includes a display, an input interface, a communication module, and an execution environment for a web browser or a native application. The terminal receives display page information from the server through the communication network and renders the content on the display. The terminal presents the explanatory character information, appeal character information, and image information to the user according to the layout specified by the display page information.

The user uses the terminal to review the generated display page. The user may edit the headline or description, adjust the order of images, or modify specific feature phrases. The terminal collects modification data and sends update information back to the server. The update information includes explicit indications of which components were changed, and the terminal may send diffs or structured update messages rather than complete page data, in order to reduce communication load. This structure allows the server to update only affected portions of the display page information, and also allows the server to feed the final, user-approved descriptions back into a training or fine-tuning process so that the generative AI model can be improved over time.

The server receives the update information and applies changes to the stored display page information. The server may also, in a further embodiment, use the update information to adapt subsequent prompt generation. For example, if the user repeatedly shortens descriptions beyond a certain length, the server modifies prompt generation rules so that future prompt sentences specify a shorter target length. This feedback mechanism leads to fewer corrections required in later interactions, which in turn reduces server processing load and improves end-to-end latency.

The server uses the management interface module to provide a management screen to the terminal. The management screen allows the user to perform publication settings, such as selecting whether a page is in draft or live status, and to perform a publication instruction. When the server receives a publication instruction, the server transmits the finalized display page information to the delivery information processing device. The delivery information processing device caches and distributes the display page information to external client devices, for example by acting as a content delivery server. By separating internal generation from external delivery, the system can minimize regeneration of pages, reduce load on the generative AI model, and maintain high throughput for external access.

The server thereby realizes more than a mere automation of human writing tasks. By defining specific data structures for classification information, feature information, prompt sentences, and templates, and by coupling these structures with neural network-based analysis and generation, the server improves the internal functioning of the computer system. The system uses structured metadata to minimize unnecessary interactions with the generative AI model, selects appropriate templates to avoid misalignment between content and layout, and uses feedback from user corrections to adjust prompt and template parameters. These features collectively result in faster page generation, reduced network traffic, and improved accuracy and consistency of generated content.

In another embodiment, the server uses alternative neural architectures or hybrid models. For example, the image analysis module may employ a vision transformer architecture, and the text analysis module may employ a recurrent neural network for compatibility with legacy environments. The generative AI model may be fine-tuned on domain-specific corpora for particular industries, and different prompt patterns may be maintained for different categories of merchandise objects. In yet another embodiment, the server may integrate a rule-based component that post-filters the generative AI outputs against a knowledge base of technical terms and standardized phrases, further enhancing consistency for technical products.

The described embodiments can be implemented in various configurations, including a single physical server, a cluster of servers, or a virtualized environment in a cloud platform. In each configuration, the server uses the described modules and data structures to perform coordinated image analysis, text analysis, template selection, prompt generation, generative AI interaction, post-processing, and page generation. By doing so, the server achieves technical effects such as reduction of manual correction steps, increased throughput of merchandise page generation, improved utilization of computational resources, and consistent quality of generated pages, and thereby provides a concrete improvement in the operation of the computer system itself.

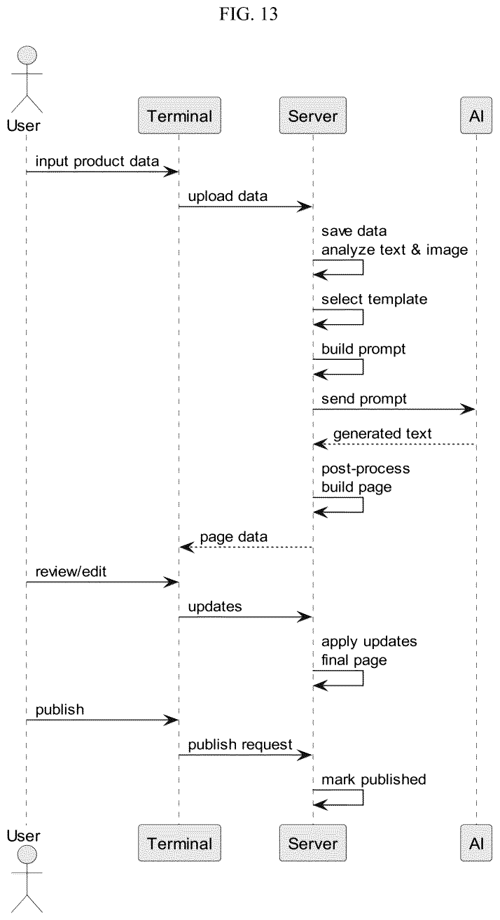

The following describes the processing flow using FIG. 13.

### Step 1

The user operates the terminal to input attribute information and select image information for a merchandise object. The terminal receives user input such as product name, category, price, free-text description, and one or more image files. The terminal validates the input (for example, checks required fields and file formats), packages the attribute information into a structured message, and attaches the image information. The terminal outputs a request message containing the attribute information and the image information and transmits this message to the server via a network.

### Step 2

The server receives the request message from the terminal as input. The server parses the message, separates the attribute information from the image information, and stores them in an information storage unit. The server assigns a unique identifier to the merchandise object, stores the attribute information in record fields associated with the identifier, and stores the image information as files or binary objects with references from the record. The server outputs a stored merchandise record including the identifier, attribute information fields, and image references.

### Step 3

The server takes the stored attribute information as input and executes character-string analysis processing. The server uses a text analysis module to tokenize the text, normalize words, and compute vector embeddings for each token or sentence. The server applies a classification algorithm, such as a neural network classifier or a support vector machine, to map the embeddings to category labels and feature labels. Based on this computation, the server outputs classification information (for example, a category hierarchy) and feature information (for example, key functional characteristics) associated with the merchandise object.

### Step 4

The server takes the stored image information as input and executes image analysis processing. The server loads each image, resizes and normalizes pixel values, and feeds the resulting tensors into an image recognition model such as a convolutional neural network. The server computes feature maps layer by layer, aggregates them into a feature vector, and applies a final classifier layer to obtain visual category labels and attribute labels. The server then outputs visual classification information and visual feature information, which may include object type, view angle, or prominent visual characteristics.

### Step 5

The server uses the textual classification information, the textual feature information, the visual classification information, and the visual feature information as input to a normalization and fusion process. The server compares overlapping labels, resolves conflicts using predetermined rules, and merges them into unified classification information and unified feature information. For example, when text and image analysis produce similar but not identical category labels, the server maps both to a standardized category in a taxonomy stored in the information storage unit. The server outputs a consolidated metadata structure containing normalized classification information and feature information for the merchandise object.

### Step 6

The server takes the consolidated metadata structure as input and executes template selection processing. The server retrieves template metadata for multiple screen templates from a template storage unit. The server computes a similarity score between the consolidated metadata and each template's profile (for example, by comparing category codes and feature vectors) and evaluates rule-based conditions. Based on these computations, the server selects one screen template that is most suitable for the merchandise object. The server outputs a selected screen template identifier and associated screen configuration information.

### Step 7

The server uses the consolidated metadata, the attribute information, and the selected screen template as input to a prompt generation module. The server composes a prompt sentence by concatenating fixed instruction fragments with dynamic data fields such as product name, category, key features, target audience, tone, and desired length. The server may include markers or section headers in the prompt sentence to clearly delineate parts of the input. The server outputs a fully formed prompt sentence that is specifically tailored to the merchandise object and the selected screen template.

### Step 8

The server uses the prompt sentence as input to a generative AI interface module. The server transmits the prompt sentence to a generative AI model and specifies generation parameters such as maximum token count and sampling settings. The generative AI model processes the prompt sentence, predicts a sequence of tokens according to its learned parameters, and returns a generated text. The server receives this generated text as output and separates it into explanatory character information (for example, a full product description) and appeal character information (for example, shorter advertising copy or taglines).

### Step 9

The server takes the explanatory character information and the appeal character information as input to a post-processing module. The server identifies structural elements such as the first sentence as a headline, subsequent sentences as body paragraphs, and list-like lines as feature bullets. The server applies rule-based filters to enforce length constraints, remove undesired phrases, and conform terminology to a predefined lexicon. The server then outputs cleaned and structured explanatory character information and appeal character information, each mapped to specific semantic roles compatible with the selected screen template.

### Step 10

The server uses the structured explanatory character information, the structured appeal character information, the attribute information, the image references, and the selected screen template as input to a page generation module. The server binds each structured text segment and each image reference to a corresponding component defined in the screen configuration information. The server constructs display page information as a data structure that includes layout instructions, text content, and resource references. The server outputs the display page information in a format suitable for rendering by a terminal, such as a markup representation and associated metadata.

### Step 11

The server takes the display page information as input and transmits it to the terminal over the network. The terminal receives the display page information as input, interprets the layout and content, and renders the merchandise page on a display device. The terminal uses its rendering engine to place the headline, descriptions, feature lists, and images according to the layout rules embedded in the display page information. The terminal outputs a visual presentation of the automatically generated merchandise page to the user.

### Step 12

The user views the rendered merchandise page on the terminal as input to a review process. The user checks the explanatory character information, the appeal character information, and the arrangement of images. When the user desires changes, the user edits specific text fields, reorders images, or adjusts display options using the input interface of the terminal. The terminal captures the modified values and constructs update information that reflects only the changed components. The terminal outputs this update information and sends it back to the server.

### Step 13

The server receives the update information from the terminal as input. The server identifies the affected parts of the display page information and the underlying merchandise record. The server updates the stored explanatory character information, appeal character information, image order, or other fields in the information storage unit according to the update information. The server then regenerates or adjusts the display page information so that it incorporates the user's corrections. The server outputs an updated version of the display page information ready for further preview or for publication.

### Step 14

The user operates the terminal to perform a publication operation as input to a publication process. The terminal displays a management screen indicating the current status of the merchandise page and provides a control for publication. When the user activates the publication control, the terminal sends a publication instruction message to the server. The server receives the publication instruction as input, changes the status of the display page information from draft to published in the information storage unit, and transmits the finalized display page information to a delivery information processing device. The delivery information processing device stores or caches the display page information and outputs it to external client devices upon request, thereby making the merchandise page accessible to external users.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In network-based commerce environments, digital content for merchandise items, such as product pages and advertising texts, is typically created and updated through fragmented and manual operations. Conventional systems often separate image capture workflows, template-based page generation, copywriting, and inventory planning into different subsystems with limited coordination. As a result, processors in such systems repeatedly perform redundant data transformations, rely on static templates without adaptive optimization, and require human operators to manually tune descriptive text and advertising content for each item and campaign. This leads to increased latency from data acquisition to publication, higher computational load due to repeated re-rendering of similar content, and inconsistent use of behavior and sales data across functions.

In particular, known content management systems do not tightly integrate generative AI models with prompt sentences that are dynamically constructed from structured merchandise information, image-derived features, viewer behavior history, and emotion analysis results. Existing implementations typically use generative models in an ad hoc manner, with manually written prompts that are not systematically linked to stored product attributes, user interaction logs, or demand forecasts. Consequently, the processor cannot automatically generate optimized merchandise pages and advertising texts in a closed feedback loop that learns from actual user responses and sales performance.

Furthermore, conventional systems log behavior history data and sales data mainly for reporting and offline analysis. These systems do not configure the processor to compute, in an integrated manner, advertising effectiveness indices and demand prediction information, nor to dynamically update replenishment timing information and subsequent prompt sentences for generative AI models based on such computed indices. As a result, inventory management and campaign optimization remain loosely coupled and are not implemented as a coherent computational pipeline that improves over time.

Additionally, many systems provide limited user interfaces for managing publication, selecting AI-generated advertising texts, and approving replenishment timing. In such systems, the processor often treats user operations as simple flags, instead of as control inputs to a unified state machine that governs page generation, ad deployment, and inventory recommendations. This limits the ability of the system to converge toward higher-quality pages and more effective campaigns with reduced manual intervention.

Accordingly, there is a need for a computer-implemented system in which a processor is configured to (i) control image acquisition for merchandise units, (ii) construct structured data and template-based page data, (iii) automatically generate and refine prompt sentences for a generative AI model using multiple heterogeneous data sources, (iv) integrate the generated text into page data and an interactive editing workflow, and (v) compute and feed back advertising effectiveness indices and demand prediction information so as to dynamically update both replenishment timing and subsequent prompt sentences. By organizing these functions into a unified processing architecture, the invention aims to reduce computational redundancy, shorten end-to-end latency from data capture to publication, and improve the technical performance of the content generation and campaign optimization pipeline executed by the processor.

The specific processing by the specific processing unit 290 of the data processing device 12 in Application Example 2 is realized by the following means.

The present invention provides a server comprising a processor and a storage device, the processor being configured to control an image acquisition device, based on shooting condition information for each merchandise unit, to acquire images required for the merchandise unit; to store the acquired images and merchandise attribute information in association with each other in the storage device; to generate structured data based on the merchandise attribute information and the images; to automatically generate merchandise information display page data by using template data in which the structured data is embedded; to generate a prompt sentence, based on at least the merchandise attribute information and the structured data, for causing a generative AI model to generate a merchandise description text and an advertising text; to input the prompt sentence to the generative AI model and obtain a generation result; to insert the obtained generation result into a predetermined region of the merchandise information display page data to update page content; to distribute the updated page data via a communication network to a user terminal to be displayed as an editing screen; to determine the page content based on an editing result received from the user terminal; and to transmit determined merchandise information and page data to an information providing apparatus for publication to external devices, and further being configured to collect behavior history data of viewers of the merchandise information and emotion analysis result data, to calculate an advertising effectiveness index and demand prediction information based on the behavior history data and the emotion analysis result data, and to dynamically update replenishment timing information and an advertising-text-generation prompt sentence according to the advertising effectiveness index and the demand prediction information. This enables the computing system to execute an integrated and adaptive pipeline in which data acquisition, template-based page generation, prompt construction, generative AI inference, user-driven refinement, and feedback from behavior and demand analytics are all coordinated by the processor, thereby reducing redundant processing, improving responsiveness of page and campaign updates, and enhancing overall technical performance of automated merchandise information generation and optimization.

The term “system” refers to a combination of hardware resources and software resources that cooperate to execute the claimed processing, including at least one processor, at least one storage device, and at least one communication interface.

The term “processor” refers to a hardware computation unit, such as a central processing unit, a graphics processing unit, or another programmable logic device, configured to execute instructions that implement the functions recited in the claims.

The term “storage device” refers to a hardware memory component, such as a semiconductor memory, a magnetic storage medium, or an optical storage medium, configured to store programs, data, and intermediate results used by the processor.

The term “information storage device” refers to a storage device used to store, in an associated manner, images, merchandise attribute information, structured data, page data, behavior history data, emotion analysis result data, and other information required for the claimed processing.

The term “image acquisition device” refers to hardware for capturing image data of a physical object, including but not limited to a digital camera, a camera module integrated in a terminal device, or a controllable imaging unit in a studio environment.

The term “shooting condition information” refers to control parameters for acquiring images, including at least an imaging angle, a number of shots, a distance, a resolution, or lighting conditions, specified for each merchandise unit.

The term “merchandise unit” refers to a single item, product, or service instance that is individually identified in the system and for which images, attributes, and sales-related information are managed.

The term “image” refers to digital visual data representing a merchandise unit, acquired by the image acquisition device and including at least pixel values and associated metadata such as capture angle and capture time.

The term “merchandise attribute information” refers to structured data describing properties of a merchandise unit, including at least an identifier, a name, a category, a price, a description, a specification, a size, a color, or other product-related characteristics.

The term “structured data” refers to data in a predetermined schema or format, such as records, key-value pairs, or hierarchical objects, generated by the processor based on merchandise attribute information and images so that the data can be programmatically processed and embedded into templates.

The term “template data” refers to predefined layout and content structures for generating merchandise information display pages, including placeholders that can be filled with structured data to produce page data in a consistent format.

The term “merchandise information display page data” refers to digital data representing a page for presenting merchandise information, including layout information, text content, image references, and interaction elements, which can be rendered by a browser or an application.

The term “page content” refers to the substantive information displayed on the merchandise information display page, including text segments, images, headings, lists, and other user-visible elements.

The term “prompt sentence” refers to a text or text-like instruction sequence input to a generative AI model, specifying at least a generation target, an output format, a writing style, an emotional tendency, or an evaluation index to control the content generated by the model.

The term “generative AI model” refers to a machine-learning-based computation model that receives a prompt sentence and optionally additional context as input and outputs generated content such as natural-language text according to learned parameters.

The term “merchandise description text” refers to generated or edited natural-language content that explains features, benefits, and specifications of a merchandise unit, intended to be displayed on a merchandise information display page.

The term “advertising text” refers to generated or edited natural-language content designed to attract user interest and promote a merchandise unit in the context of advertising or marketing.

The term “generation result” refers to one or more pieces of output data, such as merchandise description text, advertising text, or related information, produced by the generative AI model in response to an input prompt sentence.

The term “communication network” refers to a wired or wireless communication infrastructure, such as the Internet or a local network, that enables data transmission between the server, user terminals, and external devices.

The term “user terminal” refers to a computing device operated by a user, such as a smartphone, a tablet, or a personal computer, configured to display editing screens, management screens, and published pages, and to transmit user operations to the server.

The term “editing screen” refers to a user interface presented on the user terminal that displays merchandise information display page data and allows a user to modify, accept, or reject text content, images, or layout.

The term “editing result” refers to information indicating changes made by a user on the editing screen, including modifications, deletions, insertions, or rearrangements of content elements of the page.

The term “information providing apparatus” refers to a computing apparatus, such as a web server system, that receives page data and merchandise information from the processor and provides them to external devices for browsing or further distribution.

The term “viewer” refers to a person or entity that accesses and views merchandise information pages using a terminal device or browser, regardless of authentication status.

The term “behavior history data” refers to data representing actions of viewers with respect to merchandise information pages, including at least page views, dwell time, scrolling behavior, click events, add-to-cart events, and purchase events, stored in association with time and identifiers.

The term “emotion analysis result data” refers to data obtained by applying an emotion estimation process or an emotion analysis model to behavior history data, textual data, or other signals, the data including at least one emotion label and an associated emotion score.

The term “advertising effectiveness index” refers to a numerical or categorical measure computed by the processor that represents expected or observed performance of advertising content, including at least one of a click-through rate, a conversion rate, a cost efficiency, or an engagement level.

The term “demand prediction information” refers to data computed by the processor that indicates a predicted quantity or time profile of future demand for a merchandise unit based on sales data, behavior history data, or emotion analysis result data.

The term “replenishment timing information” refers to data indicating a recommended time or period in which stock of a merchandise unit should be refilled or reordered to satisfy predicted demand.

The term “advertising-text-generation prompt sentence” refers to a prompt sentence specifically constructed to cause a generative AI model to generate or revise advertising text, where the prompt sentence may encode at least advertising objectives, emotional tendencies, and evaluation criteria.

The term “feature information extracted from the images” refers to numerical or symbolic descriptors derived from image data by analysis or recognition processing, including at least category features, color features, layout features, or detected object features.

The term “generation target” refers to a specification in the prompt sentence that defines what type of content the generative AI model should produce, such as a merchandise description text, an advertising text, or a set of alternative candidates.

The term “output format” refers to a structural requirement included in the prompt sentence, specifying how the generated content should be organized, including formats such as paragraphs, bullet lists, JSON objects, or constrained-length strings.

The term “writing style” refers to characteristics of expression requested in the prompt sentence, including at least formality level, tone, voice, or linguistic complexity.

The term “emotional tendency” refers to a requested or inferred emotional orientation of the generated content, such as emphasizing excitement, joy, surprise, reliability, or calmness, as specified in or derived for the prompt sentence.

The term “evaluation index” refers to a criterion or metric described or implied in the prompt sentence or used by the processor to assess or rank generated candidates, including at least an expected advertising effectiveness index or another performance measure.

The term “advertising text candidate” refers to an individual variant of advertising text generated by the generative AI model in response to a prompt sentence, prior to selection by the processor or a user.

The term “description text candidate” refers to an individual variant of merchandise description text generated by the generative AI model in response to a prompt sentence, prior to selection by the processor or a user.

The term “management display screen” refers to a user interface displayed on the user terminal that allows a user to perform administrative operations, including publication settings, advertising text selection, and replenishment timing approval.

The term “publication setting operation” refers to a user action performed on the management display screen that instructs the system to change the publication state of merchandise information display page data, such as from unpublished to published.

The term “advertising text selection operation” refers to a user action performed on the management display screen that selects one or more advertising text candidates for use in advertising distribution.

The term “replenishment timing approval operation” refers to a user action performed on the management display screen that confirms or adjusts replenishment timing information proposed by the system.

The term “advertising distribution information” refers to data describing advertising content to be distributed, including selected advertising texts and associated metadata such as target merchandise units, channels, and schedules.

The term “inventory management information” refers to data used for managing stock levels of merchandise units, including replenishment timing information, target quantities, and status flags indicating approval or execution of replenishment.

In one embodiment, a system includes a server, at least one terminal, and at least one image acquisition device connected via a communication network. The server includes a processor and a storage device. The terminal includes a processor, a memory, a display, an input interface, and a camera module or an interface to an external camera. The image acquisition device may be integrated into the terminal as a smartphone camera, or may be implemented as a separate controllable imaging unit in a studio environment.

Server executes a program stored in the storage device to implement the functions recited in the claims. Server may use an operating system such as a general-purpose server operating system, a web application framework such as a generic web framework, a template engine such as a generic server-side template engine, a database management system such as a relational database, an image processing library, a numerical analysis library such as a data analysis library, and a machine learning library such as a tensor-based computation library. Server may also access an external generative AI model hosted on a cloud inference service, and one or more emotion analysis services.

Server configures internal data structures in the storage device to represent merchandise units, images, structured data objects, page data, behavior history records, emotion analysis results, and prompt sentences. For example, server stores merchandise attribute information in a table having fields such as item_id, name, category, price, base_description, and target_audience. Server stores image metadata in a table having fields such as image_id, item_id, angle, resolution, and file_path. Server stores behavior history data in a table having fields such as user_id, item_id, session_id, event_type, timestamp, dwell_time, and click_position. Server stores emotion analysis result data in a table having fields such as user_id, item_id, emotion_label, and emotion_score.

Server uses the structured data to generate merchandise information display page data. Server applies a template engine to combine template data with structured data. Template data may be stored as files containing markup with placeholders. Structured data may be stored as hierarchical objects in the storage device, for example as key-value pairs or serialized objects. Server merges template data and structured data by substituting placeholders in the template with actual values from the structured data. This merging reduces redundant parsing and string concatenation operations because server can operate on structured objects instead of repeatedly scanning unstructured text.

Terminal controls the image acquisition device to capture images of each merchandise unit. Terminal receives shooting condition information from the server, including angles and the number of shots. Terminal displays a guide overlay on the display to indicate the required angle and framing. Terminal uses the camera hardware to capture images with specified resolution and exposure. Terminal associates the captured images with the merchandise unit identifier and transmits the image data and associated metadata to the server via the communication network using a structured protocol such as HTTP over TLS.

Server receives the image data and metadata and stores them in the storage device. Server may preprocess the images using an image processing library to normalize resolution, aspect ratio, and compression. For instance, server may downscale images to multiple sizes and generate thumbnails. By storing images in normalized formats and recording their characteristics in structured metadata, server can later serve appropriate image resolutions to different devices and reduce bandwidth usage.

Server constructs a prompt sentence for a generative AI model using multiple sources of information. Server extracts fields from merchandise attribute information, such as category, material, price range, and base description. Server may also extract feature information from images by applying feature extraction algorithms such as convolutional filters that detect edges, colors, and salient regions. Server converts these features to compact descriptors or symbolic labels such as “red color,” “casual style,” or “outdoor usage.” Server further aggregates behavior history data and emotion analysis result data for the merchandise unit to derive tendencies such as “high excitement,” “moderate surprise,” or “low anger.”

Server then generates a prompt sentence in natural language that encodes these multiple aspects. For example, server may generate a prompt sentence such as: “Generate an engaging product description for the following item. Category: clothing. Name: ‘Summer Logo T-shirt’. Photos: 3. Base description: ‘Lightweight cotton T-shirt with a simple logo, suitable for summer.’ Target audience: men in their twenties. Use a casual and friendly tone, emphasize excitement and comfort, and output a catchy title under 60 characters and a 150-word description with three bullet points.”

In another example, server may generate a prompt sentence for advertising optimization such as:

“This product is a fashion item for women in their twenties. Past campaigns had a high click-through rate, and emotion analysis shows high excitement and joy. Generate three short Japanese ad copies under 50 characters that emphasize excitement and style.”

Server encodes the generation target, output format, writing style, emotional tendency, and evaluation index explicitly or implicitly in the prompt sentence. Server may construct the prompt sentence according to a rule-based template generator that selects segments and modifiers based on category, emotion scores, and historical performance. This rule-based generator allows server to produce prompt sentences with a consistent structure that is optimized for the generative AI model.

Server communicates with the generative AI model via an application programming interface. In one embodiment, the generative AI model is a neural network having a transformer architecture trained on large-scale text corpora. The model may comprise multiple layers of self-attention and feed-forward networks with learned weight parameters. During inference, server transmits the prompt sentence as tokenized text, along with parameters such as maximum output length, sampling temperature, and top-k or nucleus sampling thresholds. The generative AI model performs autoregressive generation, producing tokens sequentially according to learned probability distributions.

Server receives the generated tokens and reconstructs them into text. Server partitions the generated text into segments, such as title, description, and bullet points, based on delimiters or specific phrases included in the prompt sentence. Server may perform quality checks, such as limiting maximum length, checking for disallowed terms, or ensuring inclusion of specified attributes. Server stores the generation result in association with the merchandise unit and the underlying prompt sentence in the storage device.

Server integrates the generation result into the merchandise information display page data. Server updates the structured data object for the merchandise unit to include generated fields such as ai_title, ai_description, and ai_ad_texts. Server regenerates page data by applying the template engine with the updated structured data. Server then transmits the updated page data to the terminal to be displayed as an editing screen.

Terminal displays the editing screen, showing the generated text and associated images. Terminal allows the user to modify the generated text, rearrange images, and adjust layout elements. User can, for example, rewrite parts of the description or adjust the tone of the generated advertising text. Terminal transmits editing results back to the server as structured update commands, specifying which fields have been changed.

Server receives the editing results and updates the structured data and page data accordingly. Server marks the edited content with metadata indicating that it has been user-modified. Server stores both the original generated text and the edited text for subsequent analysis. Server also updates a state field in the page data to indicate whether the page is in draft, review, or published status.

Server transmits determined merchandise information and page data to an information providing apparatus, such as a web server, to make the page publicly accessible. Server may generate static files or dynamically rendered responses that are delivered to external devices. By using structured data and template engines, server can produce responses more quickly than systems that assemble content from multiple loosely coupled modules, thereby reducing latency under high load.

Server logs behavior history data when external viewers access merchandise information pages. Server embeds scripts in the page data to capture events such as page load, scroll depth, click events, add-to-cart events, and purchase events. These scripts transmit event information to server in real time or batch mode. Server records each event in the behavior history table, allowing aggregated analysis.

Server calculates an advertising effectiveness index based on behavior history data and, optionally, campaign metadata. For instance, server may compute click-through rate as the ratio of advertisement clicks to impressions, and conversion rate as the ratio of purchases to clicks. Server may also compute engagement metrics such as average dwell time on a page. Server may implement these calculations using a numerical analysis library to efficiently process large volumes of event data with vectorized operations, reducing processing time compared to row-by-row manual queries.

Server applies an emotion analysis process to behavior history data or associated textual data such as reviews. In one embodiment, server uses an external emotion analysis service that applies a classification model trained on labeled data. The model may be a neural network that outputs emotion scores for labels such as joy, excitement, surprise, anger, and sadness. Server transmits relevant text or aggregated behavior signals to the service and receives emotion labels and scores. Server stores these results in the emotion analysis result data table.

Server calculates demand prediction information by combining sales history data, behavior history data, and emotion analysis result data. Server loads time-series data for each merchandise unit from the storage device and applies statistical or machine-learning models to estimate future demand. For example, server may use a forecasting model that incorporates seasonal components and trend components. Server may also include emotion scores as exogenous variables, so that positive emotion spikes can adjust demand upward. Server implements this model using a machine learning library, enabling efficient training and inference with vectorized operations and automatic differentiation.

Server determines replenishment timing information by applying rules to the demand prediction information. For instance, server may estimate the time when remaining stock will be exhausted under the predicted demand, and subtract a lead time to compute a recommended reorder date. Server may adjust this date earlier when emotion scores and advertising effectiveness indices indicate surge interest. Server stores the replenishment timing information as structured data.

Server generates an advertising-text-generation prompt sentence that incorporates advertising effectiveness indices, demand prediction information, and emotion analysis results. For example, server may generate a prompt sentence such as:

“This product has shown increasing demand and high excitement in recent weeks. Generate two new short advertising texts under 40 characters that emphasize durability and surprise, suitable for mobile banner ads.”

By encoding these signals into the prompt sentence, server guides the generative AI model to produce advertising text that is more likely to perform well under current conditions. Because server can systematically construct prompt sentences from structured data, the system achieves a level of adaptation and optimization that is not feasible with static, manually written prompts.

Terminal displays a management display screen that allows the user to control publication settings, advertising text selection, and replenishment timing approval. Terminal retrieves from the server a list of merchandise units and associated page states, advertising text candidates, and recommended replenishment timings. Terminal renders graphical user interface elements such as toggles, selection lists, and confirmation buttons. User selects which advertising text candidate to adopt and whether to accept or adjust the proposed replenishment timing. Terminal transmits these operations to the server as structured commands.

Server processes the operations received from the terminal. When user performs a publication setting operation, server changes the state of the page data to published and updates the information providing apparatus configuration. When user performs an advertising text selection operation, server registers the selected advertising text as advertising distribution information. When user performs a replenishment timing approval operation, server records the replenishment timing information as inventory management information and may transmit notifications to other systems. These operations update the internal state machine of the system, ensuring that only approved content and timings are used in subsequent processes.

This configuration improves computer technology in several ways. First, server reduces redundant computation by using structured data and templates so that content generation and updates require fewer repeated parsing and rendering steps. Second, server improves data management by organizing images, attributes, behavior history, emotion scores, and model outputs in normalized structures that can be efficiently queried and joined. Third, server improves computational efficiency and latency by consolidating content generation, behavior analytics, and decision support into a single coordinated pipeline that minimizes data transfers between separate subsystems.

Moreover, the use of generative AI models with dynamically constructed prompt sentences is not a mere automation of human copywriting. Server uses a specific combination of structured features, behavior-derived indices, and emotion scores to construct prompt sentences according to pre-defined templates and rules. This non-conventional approach allows the generative AI model to exploit high-dimensional relationships that human operators cannot practically consider in real time. As a result, server achieves improved prediction accuracy for effective text variants and faster convergence to well-performing content.

In addition, server configures the generative AI model and related modules to operate with specific numerical and structural constraints, such as output length limits, tone constraints, and evaluation-based selection, to ensure predictable performance. Server may implement an internal scoring module that evaluates candidates using the advertising effectiveness index, thereby closing a feedback loop between model outputs and observed performance. This feedback loop refines prompt sentence construction and candidate selection strategies over time, which constitutes an improvement in the way the computer system processes and utilizes data.

In other embodiments, server may employ different model architectures. For example, server may use an encoder-decoder architecture for conditional text generation, or may use specialized sentiment-conditioned language models. Server may fine-tune such models on domain-specific data using supervised learning, where the loss function measures divergence between generated text and reference text, or measures predicted performance error based on historical campaign outcomes. Server may update model weights using gradient descent or variants thereof. Server may also apply data augmentation techniques such as paraphrasing or synonym substitution in training data to increase robustness.

Server may be configured in a modular architecture with distinct but interconnected components, such as an image handling module, a structured data generation module, a template rendering module, a prompt construction module, a generative inference module, a behavior logging module, an analytics module, and a decision support module. Data flows sequentially and iteratively between these modules under the control of the processor. This modular structure allows parallelization and caching strategies that further improve processing speed and reduce network traffic.

Terminal may be implemented on various hardware platforms. In one variation, terminal is a handheld device with limited processing power and memory. In such a case, server performs most heavy computations, while terminal performs lightweight rendering and input handling. In another variation, terminal is a workstation that can locally cache page data and perform some template rendering to reduce server load and network latency.

In alternative implementations, server may control an independent robotic imaging rig as the image acquisition device. Server may send angle and positioning commands to actuators, receive feedback from sensors, and iteratively adjust camera position to satisfy shooting condition information. By embedding the acquisition step into the overall pipeline, server can tightly couple image capture parameters with downstream content generation and analytics, further optimizing the system.

Through these embodiments, server, terminal, and user cooperate to implement the claimed system in a manner that concretely ties generative AI processing and prompt sentence construction to physical device control, structured data transformations, and technical improvements in computing performance, rather than merely automating an abstract business workflow.

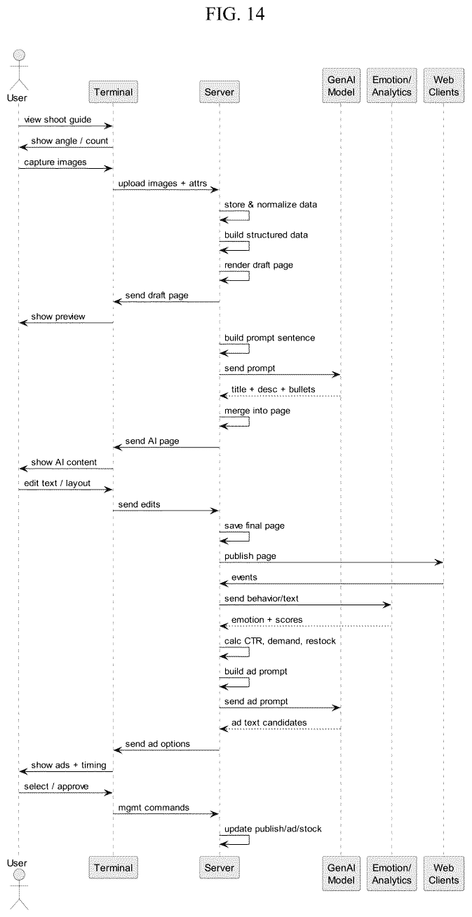

The following describes the processing flow using FIG. 14.

### Step 1

Server prepares shooting conditions for each merchandise unit.

Server uses as input merchandise master data (item identifiers, categories, required views) stored in a database. Server performs data processing to map each category to a predefined set of angles, number of shots per angle, and resolution requirements. Server generates as output shooting condition information, for example “item_id=123, angles=[0°, 45°, 90°], shots_per_angle=2, resolution=1920×1080,” and sends this information to the terminal via an API.

### Step 2

Terminal receives shooting conditions and guides image capture.

Terminal uses as input the shooting condition information from the server. Terminal performs UI rendering to display an overlay indicating the required angle and remaining shot count, and controls the camera hardware to set focus, exposure, and resolution. Terminal captures images as the user presses a shutter button, associates each captured image with the corresponding item identifier and angle, and outputs a set of image files and metadata records (item_id, angle, shot_index, timestamp, resolution) stored temporarily in device memory.

### Step 3

User positions merchandise and captures required images.

User uses as input the on-screen instructions shown by the terminal (required angle, number of remaining shots). User physically rotates, moves, or adjusts the merchandise so that it aligns with the guide, and presses the capture control when the preview is acceptable. User reviews each captured frame on the display, and based on visual quality assessment, either accepts or rejects the shot. User outputs a curated set of images for each required angle that are marked as “accepted” in the terminal's local data structure.

### Step 4

Terminal uploads images and merchandise attributes to the server.

Terminal uses as input the accepted image files, their metadata, and merchandise attribute information entered by the user (such as name, base description, price, category, and specifications). Terminal packages these data into a structured request (for example multipart/form-data plus JSON), performs data serialization, and transmits the request to the server over a secure connection. Terminal outputs an upload transaction that contains binary image data and structured attribute fields associated with each item identifier.

### Step 5

Server stores and normalizes uploaded data.

Server uses as input the upload transaction containing image files, image metadata, and merchandise attribute information. Server performs data validation (file format check, size check, required-field check) and image preprocessing (resizing, compression, thumbnail generation) using an image-processing library. Server generates as output normalized image files stored in a file system or object storage, and normalized records inserted into database tables for items and images, each record referencing the stored file paths and cleaned attribute values.

### Step 6

Server generates structured data objects for page construction.

Server uses as input the normalized merchandise attribute records and image metadata stored in the database. Server performs data aggregation and transformation to build a structured data object per merchandise unit, including keys such as title, price, base_description, image_list, and technical specifications. Server outputs these structured data objects, for example as in-memory hierarchical structures, and stores them in a cache or table prepared for template rendering.

### Step 7

Server renders initial merchandise information display page data.

Server uses as input the structured data object for a merchandise unit and template data for a corresponding category. Server executes a template engine that substitutes placeholders in the template with actual values from the structured data, and performs formatting operations such as inserting image URLs, generating feature lists, and assembling specification tables. Server outputs initial page data, such as HTML or JSON-based view definitions, that represent a draft merchandise page without AI-optimized text.

### Step 8

Terminal retrieves and displays the initial page for review.

Terminal uses as input the initial page data received from the server. Terminal parses the page data and performs UI layout rendering, loading referenced images from the server's static file endpoints. Terminal outputs a visual preview on the display that shows an initial page structure with base text and images, enabling the user to inspect layout and basic content.

### Step 9

Server constructs a prompt sentence for a generative AI model.

Server uses as input the structured data object (including category, material, price, target audience, base description), optional image-derived feature information (such as dominant colors or style tags), and historical performance indicators for the merchandise class. Server performs data concatenation and rule-based template selection to assemble a natural-language prompt sentence that encodes generation target, desired output format, writing style, and emotional tendency. Server outputs a prompt sentence such as “Generate an engaging product description for the following item. Category: clothing. Name: ‘Summer Logo T-shirt’. Photos: 3. Base description: ‘Lightweight cotton T-shirt with a simple logo, suitable for summer.’ Target audience: men in their twenties. Use a casual and friendly tone, emphasize excitement and comfort, and output a catchy title under 60 characters and a 150-word description with three bullet points.”

### Step 10

Server sends the prompt sentence to the generative AI model and obtains generated text.

Server uses as input the constructed prompt sentence and generation parameters (such as maximum length, sampling temperature, and number of candidates). Server tokenizes the prompt, calls the generative AI model through a network API, and triggers the model's inference process, in which the underlying neural network computes probability distributions over tokens and sequentially generates output tokens. Server collects the generated tokens, decodes them into text, and outputs generation results such as a title string, a description paragraph, and a list of bullet points.

### Step 11

Server integrates generated text into the structured data and page data.

Server uses as input the generation results from the generative AI model and the existing structured data object for the merchandise unit. Server performs data mapping to assign generated segments to specific fields, such as ai_title, ai_description, and ai_features. Server regenerates the merchandise information display page data by re-running the template engine with the updated structured data, so that AI-generated text appears in designated regions. Server outputs AI-enhanced page data ready for user review.

### Step 12

Terminal presents an editing screen with AI-generated content.

Terminal uses as input the AI-enhanced page data from the server. Terminal renders the content, visually distinguishing AI-generated sections (for example by labels or highlighting). Terminal provides input controls for text editing and image reordering. Terminal outputs edited field values and layout changes as a set of user modifications captured in its local memory until submission.

### Step 13

User reviews and edits AI-generated descriptions and layout.

User uses as input the AI-generated texts and page layout shown on the terminal. User reads the title and description, modifies specific phrases to match brand tone, adds or removes bullet points, and drags images to reorder the gallery. User decides when the page content is satisfactory and then activates a confirmation control. User outputs an edit decision and modified content, which the terminal encodes as structured update data.

### Step 14

Terminal submits editing results to the server.

Terminal uses as input the set of modifications produced by the user, including new text values, deleted segments, and updated image order. Terminal constructs an update request containing item identifiers, field names, and new values, and transmits it to the server via the communication network. Terminal outputs a transaction that represents the user-approved version of the content.

### Step 15:

Server applies user edits and finalizes the page data.

Server uses as input the update transaction from the terminal and the AI-enhanced page data stored in the database. Server performs a merge operation, overwriting or augmenting AI-generated fields with user-provided text and updating image sequence indices. Server updates the structured data object and the stored page data, and sets a status flag to “final” or “ready for publication.” Server outputs finalized page data and associated metadata that reflect both AI generation and human refinement.

### Step 16

Server publishes the finalized page to an information providing apparatus.

Server uses as input the finalized page data and publication settings (such as URL path and visibility flags). Server generates static or dynamically served responses, registers routing information on a web server, and stores any necessary cache entries. Server outputs publicly accessible merchandise information display pages, which can be requested by external browsers and client applications.

### Step 17

Server logs behavior history data from external viewers.

Server uses as input event reports sent from client-side scripts embedded in the published pages, including events like page_view, scroll, click, add_to_cart, and purchase, each associated with item identifiers and timestamps. Server performs event parsing and normalization, and writes the events as rows into a behavior history table. Server outputs aggregated logs that continuously grow as more viewers interact with the merchandise pages.

### Step 18

Server computes aggregated behavior features and advertising effectiveness indices.

Server uses as input the behavior history records stored in the behavior history table and any campaign metadata. Server groups events by merchandise unit and time window, and computes features such as total impressions, total clicks, clicks per impression, purchases per click, average dwell time, and scroll-depth statistics. Server calculates advertising effectiveness indices like click-through rate and conversion rate using arithmetic operations on the aggregated counts. Server outputs a set of numerical indices for each merchandise unit and campaign segment.

### Step 19

Server obtains emotion analysis result data from behavior and text.

Server uses as input selected behavior-derived features (for example, very long dwell time or high interaction frequency) and text data such as user reviews or feedback comments. Server assembles input payloads for an emotion analysis model and submits them to an emotion analysis service. The model processes the payload, performing feature extraction and classification to produce emotion labels and scores. Server receives these scores and writes them to an emotion analysis result table, outputting structured emotion labels such as joy, excitement, or surprise with associated scores.

### Step 20

Server predicts demand and determines replenishment timing.

Server uses as input sales history data for merchandise units, behavior-derived features, and emotion analysis result data. Server constructs time-series vectors of sales and uses forecasting algorithms to estimate future demand, optionally including emotion scores and advertising indices as exogenous variables. Server computes predicted future sales volumes and identifies projected stock-out times based on current inventory data. Server calculates recommended replenishment timing by subtracting supply lead times from projected stock-out times. Server outputs replenishment timing information and, optionally, recommended reorder quantities.

### Step 21

Server generates updated advertising-text-generation prompt sentences.

Server uses as input the advertising effectiveness indices, demand prediction information, emotion analysis results, and merchandise attributes. Server applies rule-based logic to identify which items require refreshed advertising content (for example, items with rising demand and high excitement scores). Server composes new prompt sentences that explicitly instruct the generative AI model to produce advertising text tailored to the current emotional and demand context. For instance, server may output a prompt sentence such as “This product has shown increasing demand and high excitement in recent weeks. Generate two new short advertising texts under 40 characters that emphasize durability and surprise, suitable for mobile banner ads.”

### Step 22

Server generates and scores new advertising text candidates using the generative AI model.

Server uses as input the updated prompt sentences and generation parameters. Server sends each prompt to the generative AI model and receives multiple candidate advertising texts. Server then evaluates these candidates using a scoring function that combines learned preferences and advertising effectiveness indices, for example by predicting which candidate will yield the highest expected click-through rate based on historical patterns. Server outputs a ranked list of advertising text candidates associated with each merchandise unit.

### Step 23

Terminal displays a management screen for publication, ad selection, and replenishment approval.

Terminal uses as input the finalized page data, ranked advertising text candidates, and replenishment timing information received from the server. Terminal renders a management display that shows page status, candidate advertising texts with associated scores, and recommended replenishment dates. Terminal provides interactive controls for toggling publication, selecting one or more advertising texts, and approving or adjusting replenishment timing. Terminal outputs user operations captured as structured management commands.

### Step 24

User performs management operations for content and inventory.

User uses as input the information shown on the management screen, including AI-ranked advertising texts and system-recommended replenishment dates. User compares candidate ad texts, selects those that align with brand strategy, and decides whether to accept, move forward, or delay replenishment suggestions. User confirms changes by activating publication, selection, and approval controls. User outputs a set of decisions that reflect both business judgment and technical recommendations.

### Step 25

Terminal transmits management commands to the server.

Terminal uses as input the user's management decisions, including flags indicating which pages to publish, which advertising texts to adopt, and how to set replenishment timing. Terminal encodes these decisions in update messages addressed to the server and sends them over the network. Terminal outputs structured control messages that instruct the server to apply state changes.

### Step 26

Server updates publication state, advertising distribution information, and inventory management information.

Server uses as input the control messages from the terminal. Server updates the publication state of page data by marking pages as published or unpublished and notifying the information providing apparatus accordingly. Server registers selected advertising texts as advertising distribution information, associating them with specific campaigns or channels. Server records approved replenishment timing information in inventory management tables, potentially triggering downstream notifications or order generation in integrated systems. Server outputs an updated internal state in which page visibility, advertising content, and inventory-related timing are all aligned with the latest user-approved configuration.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

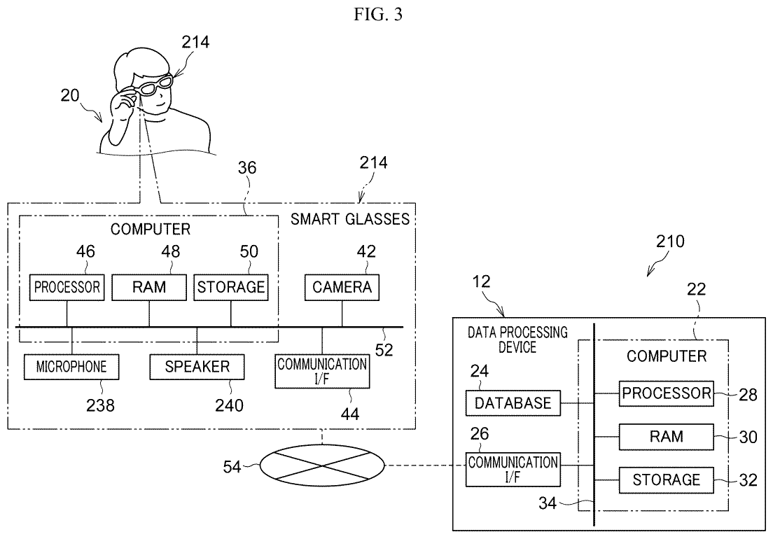

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

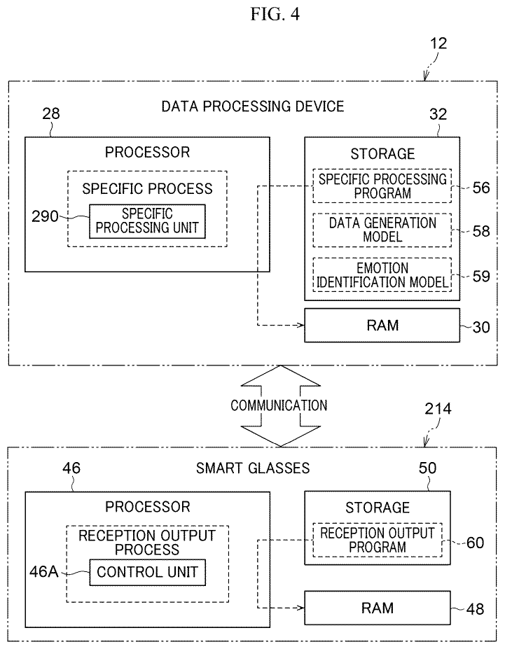

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

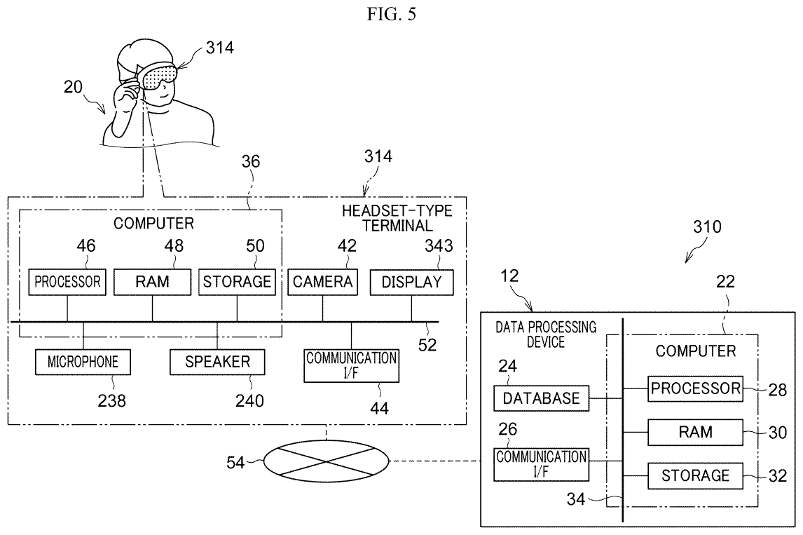

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

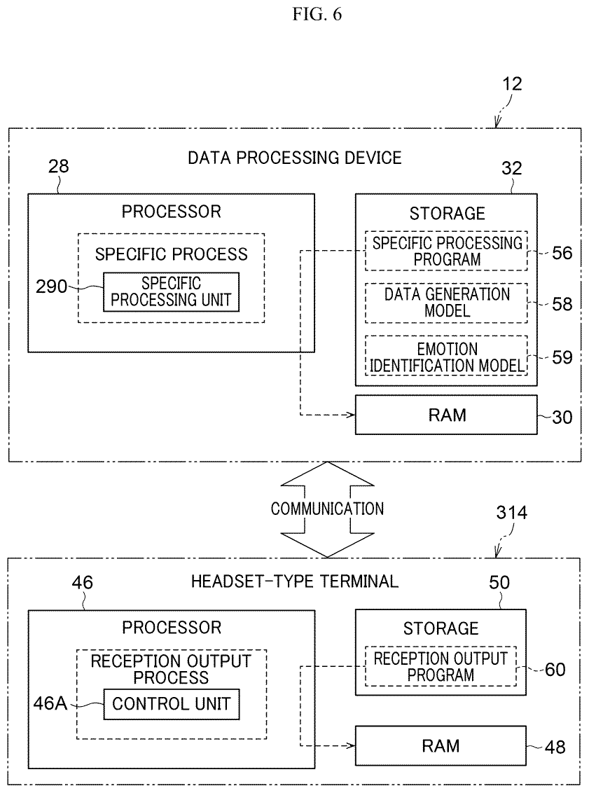

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

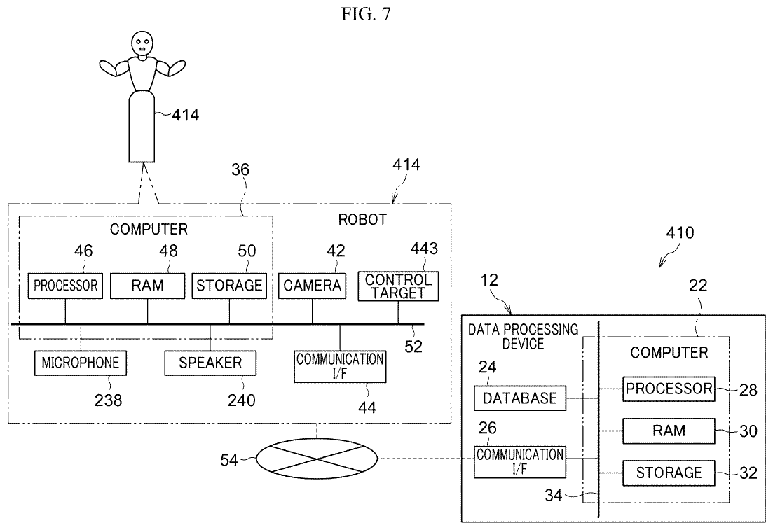

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

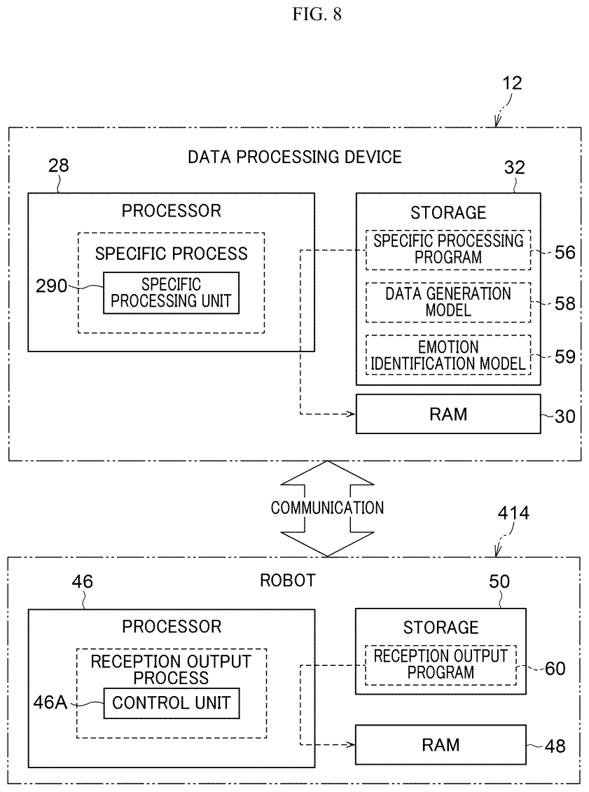

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

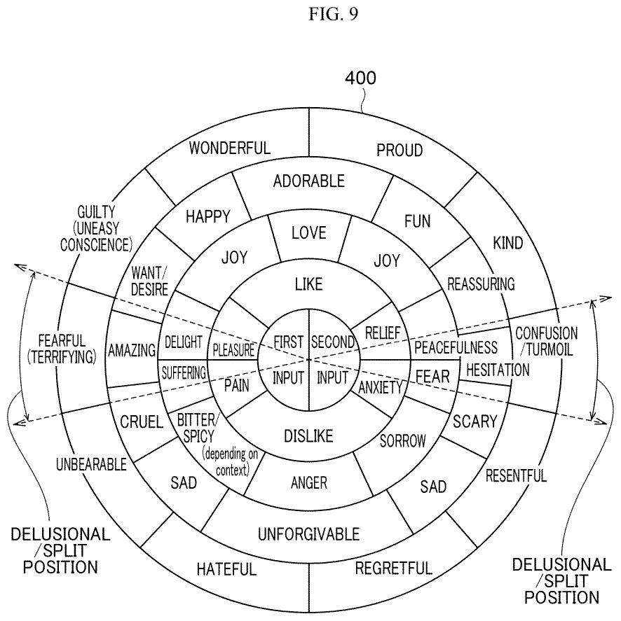

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

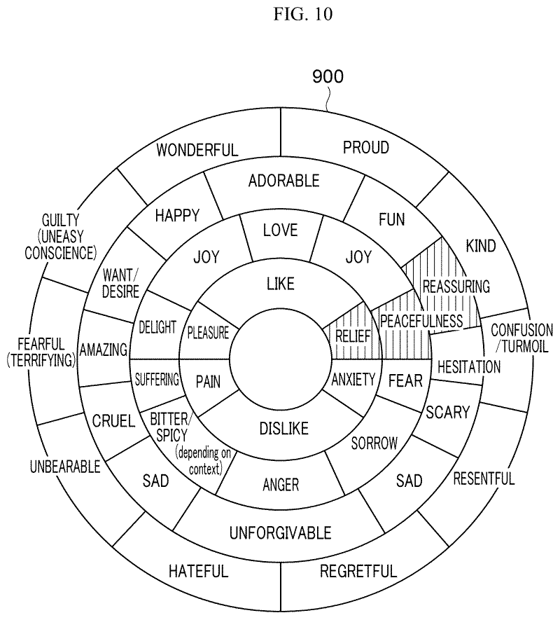

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

Example 1

### Supplementary 1)

A system comprising a processor,
wherein the processor is configured to
acquire, for each merchandise item, required merchandise images based on predetermined imaging conditions,
receive, from a terminal, the merchandise images and structured attribute information related to the merchandise item, perform conversion processing on the merchandise images to convert the merchandise images into predetermined image formats and resolutions by using image processing software, and register the merchandise images and the attribute information in association with each other in a data set in a storage device,
extract, based on the attribute information and information related to the merchandise images registered in the data set, keyword information and numerical information representing characteristics of the merchandise item, and generate a prompt sentence including a result of the extraction, thereby forming instruction information for inputting the prompt sentence to a generative AI model,
transmit, via a communication network, the prompt sentence to the generative AI model, obtain, from the generative AI model, generated text including at least one of a product description and an advertising short text corresponding to the merchandise item, and store the generated text in the data set in association with the merchandise item,
transmit the generated text to the terminal in a format displayable as a management screen, receive, through the management screen, correction information for the generated text, and update the generated text in the data set based on the correction information, and
receive, from the terminal, state information indicating a publication state of merchandise information reflecting the correction information, and, based on the state information, make the merchandise information distributable as publication information to an external destination via a web provision interface.

### Supplementary 2

The system according to supplementary 1,
wherein the processor is configured to
extract, from the merchandise images and the attribute information registered in the data set, a plurality of feature terms including terms related to material, color, dimension, price, classification information, and usage scene, and automatically generate the prompt sentence by inserting the feature terms into a predetermined sentence template.

### Supplementary 3

The system according to supplementary 1,
wherein the processor is configured to
display, on the management screen, an operation section indicating the publication state of the merchandise information, update the state information in accordance with an operation of the operation section by a user, and make the merchandise information distributable as the publication information from the web provision interface based on the state information.

Application Example 1

### Supplementary 1

A system comprising a processor,
wherein the processor is configured to
generate an imaging plan for each merchandise item, the imaging plan including an imaging angle and a number of images as imaging conditions, and transmit an imaging instruction based on the imaging plan to a communication terminal,
receive merchandise images acquired by the communication terminal in accordance with the imaging plan, store the merchandise images in a storage device, and perform image recognition processing on the merchandise images to extract merchandise attribute information,
construct merchandise information including at least a merchandise name, a price, a material, and a dimension based on the merchandise attribute information and the merchandise images, and generate a prompt sentence to be input to a generative AI model on the basis of the merchandise information and the merchandise images,
input the prompt sentence to the generative AI model to obtain a merchandise description text and an advertising text, and automatically generate a plurality of merchandise display page candidates by combining the merchandise information, the merchandise images, the merchandise description text, and the advertising text,
transmit the merchandise display page candidates to a user terminal, update the merchandise display page candidates based on editing operation information received from the user terminal, and generate a final merchandise display page approved by a user, and
upload the final merchandise display page to an information providing apparatus for publication so that the final merchandise display page is viewable on an electronic commerce site.

### Supplementary 2

The system according to supplementary 1,
wherein the processor is configured to
analyze attribute terms included in the merchandise attribute information extracted by the image recognition processing and in the merchandise information, and generate the prompt sentence including the attribute terms as keywords to be input to the generative AI model.

### Supplementary 3

The system according to supplementary 1,
wherein the processor is configured to
cause a management display screen to be presented on the user terminal, and, in response to a publication setting operation and a publication instruction operation performed via the management display screen, upload the final merchandise display page to the information providing apparatus for publication.

### Example 2

### Supplementary 1

A system comprising a processor,
wherein the processor is configured to
acquire image information for each merchandise object under a plurality of imaging conditions and store the acquired image information and attribute information in an information storage unit,
perform character-string analysis processing and image analysis processing on the stored image information and attribute information to extract classification information and feature information of the merchandise object,
select, on the basis of the extracted classification information and feature information, a screen template suitable for the merchandise object from a template storage unit in which a plurality of screen configuration information items are registered,
generate, in correspondence with the selected screen template, a prompt sentence including the classification information, the feature information, and the attribute information, and input the prompt sentence to a generative artificial intelligence model to cause the generative artificial intelligence model to generate explanatory character information and appeal character information,
apply the explanatory character information and the appeal character information generated by the generative artificial intelligence model, together with the image information and the attribute information, to the selected screen template to automatically generate display page information relating to the merchandise object,
transmit the generated display page information to a terminal device, receive update information based on confirmation and correction operations performed on the terminal device, and update the display page information, and
in response to a publication operation performed via a management screen with respect to the updated display page information, transmit the updated display page information to a delivery information processing device to enable provision of the updated display page information to an external destination.

### Supplementary 2

The system according to supplementary 1,
wherein the processor is configured to
generate the prompt sentence including the classification information, the feature information, and terminology information extracted from the image information and the attribute information, and input the prompt sentence to the generative artificial intelligence model to cause the generative artificial intelligence model to generate the explanatory character information and the appeal character information.

### Supplementary 3

The system according to supplementary 1,
wherein the processor is configured to
cause the terminal device to display the management screen, accept a publication setting and a publication instruction operation performed by a user on the management screen, and, in response to the publication instruction operation, transmit the display page information to the delivery information processing device to set the display page information to a published state.

Application Example 2

### Supplementary 1

A system comprising a processor,
wherein the processor is configured to
control an image acquisition device, based on shooting condition information for each merchandise unit, to acquire images required for the merchandise unit, and
store the acquired images and merchandise attribute information in association with each other in an information storage device, and
generate structured data based on the merchandise attribute information and the images, and automatically generate merchandise information display page data by using template data in which the structured data is embedded, and
generate a prompt sentence, based on the merchandise attribute information and the structured data, for causing a generative AI model to generate a merchandise description text and an advertising text, and input the prompt sentence to the generative AI model to obtain a generation result, and
insert the obtained generation result into a predetermined region of the merchandise information display page data to update page content, and distribute the updated page data via a communication network to a user terminal to be displayed as an editing screen, and determine the page content based on an editing result received from the user terminal, and transmit determined merchandise information and page data to an information providing apparatus for publication to external devices, and
collect behavior history data of viewers of the merchandise information and emotion analysis result data, calculate an advertising effectiveness index and demand prediction information based on the behavior history data and the emotion analysis result data, and dynamically update replenishment timing information and an advertising-text-generation prompt sentence according to the advertising effectiveness index and the demand prediction information.

### Supplementary 2

The system according to supplementary 1,
wherein the processor is configured to
generate the prompt sentence, based on the merchandise attribute information, feature information extracted from the images, the behavior history data, and the emotion analysis result data, the prompt sentence including at least a generation target, an output format, a writing style, an emotional tendency, and an evaluation index, input the prompt sentence to the generative AI model to obtain a plurality of advertising text candidates and description text candidates, and select the candidates based on the advertising effectiveness index.

### Supplementary 3

The system according to supplementary 1,
wherein the processor is configured to
cause a management display screen to be displayed on the user terminal, receive, via the management display screen, a publication setting operation, an advertising text selection operation, and a replenishment timing approval operation, publish the page data in response to the publication setting operation, register a selected advertising text as advertising distribution information in response to the advertising text selection operation, and record the replenishment timing information as inventory management information in response to the replenishment timing approval operation.

What is claimed is:

1. A system comprising:
circuitry configured to:
receive, via a communication interface coupled to a packet-switched network, media data and structured attribute records associated with an item entity from a remote terminal, perform format conversion processing on the media data, and register the converted media data and the structured attribute records in association with the item entity in a data set stored on a storage device;
extract, from the data set, feature terms and numerical descriptors representing characteristics of the item entity, and construct a prompt data structure by inserting the extracted feature terms into a predefined instruction template to form input for a generative information processing model;
transmit the prompt data structure to the generative information processing model via the communication interface, obtain generated text data from the generative information processing model, and store the generated text data in the data set in association with the item entity; and
transmit the generated text data as a notification data packet to the remote terminal, receive correction data from the remote terminal, update the generated text data in the data set based on the correction data, and, upon receiving state information indicating a distribution state from the remote terminal, make content data reflecting the correction data distributable via a web provision interface coupled to the packet-switched network.

2. The system according to claim 1, wherein the circuitry is configured to perform the format conversion processing by converting the media data into a predetermined image format and a predetermined resolution by using an image processing module.

3. The system according to claim 2, wherein the circuitry is configured to perform image recognition processing on the converted media data to extract additional attribute information and incorporate the additional attribute information into the structured attribute records stored in the data set.

4. The system according to claim 1, wherein the feature terms include terms related to at least two of material, color, dimension, numerical value, classification, and usage context of the item entity.

5. The system according to claim 1, wherein the circuitry is configured to construct the prompt data structure by selecting the predefined instruction template from a plurality of instruction templates based on a classification of the item entity.

6. The system according to claim 5, wherein the circuitry is configured to generate a plurality of candidate output configurations by combining the generated text data with the media data and the structured attribute records according to different layout templates, and to transmit the plurality of candidate output configurations to the remote terminal for selection.

7. The system according to claim 1, wherein the circuitry is configured to analyze the media data and the structured attribute records jointly to derive classification information and feature information for the item entity, and to select a display template from a plurality of registered display templates based on the classification information.

8. The system according to claim 7, wherein the circuitry is configured to construct the prompt data structure to include both the feature information and an identifier of the selected display template, such that the generative information processing model produces the generated text data aligned with a structure of the selected display template.

9. The system according to claim 1, wherein the circuitry is configured to receive the correction data through a management interface rendered on a display controller of the remote terminal, and to update the prompt data structure based on the correction data to obtain refined generated text data from the generative information processing model.

10. The system according to claim 1, wherein the circuitry is configured to generate an imaging plan specifying imaging angles and a number of required images as imaging conditions for the item entity, and to transmit an imaging instruction based on the imaging plan to the remote terminal prior to receiving the media data.

11. The system according to claim 10, wherein the imaging plan is generated based on a classification of the item entity stored in the data set.

12. The system according to claim 1, wherein the circuitry is configured to acquire interaction log records from the web provision interface, compute an effectiveness index based on the interaction log records and transaction records associated with the item entity, and dynamically update the prompt data structure based on the effectiveness index to obtain updated generated text data from the generative information processing model.

13. The system according to claim 12, wherein the circuitry is configured to compute demand prediction information based on the transaction records and the interaction log records, and to generate replenishment timing information for the item entity based on the demand prediction information.

14. The system according to claim 1, wherein the circuitry is configured to acquire user interaction data from the remote terminal, perform affective state estimation processing on the user interaction data to estimate an emotional state of a user, and adjust a tone parameter or a detail level parameter of the prompt data structure based on the estimated emotional state.

15. The system according to claim 14, wherein the affective state estimation processing includes analyzing at least one of text input data, audio signal data, and image frame data received from the remote terminal.

16. The system according to claim 1, wherein the generated text data includes at least one of a descriptive text passage corresponding to the item entity and a short-form promotional text passage corresponding to the item entity.

17. The system according to claim 1, wherein the circuitry is configured to render the generated text data, the media data, and the structured attribute records as a composite display page, and to transmit the composite display page to the remote terminal as the notification data packet.

18. A system comprising:
circuitry configured to:
receive, via a communication interface coupled to a packet-switched network, media data and structured attribute records associated with an item entity from a remote terminal, perform format conversion processing on the media data, and register the converted media data and the structured attribute records in association with the item entity in a data set stored on a storage device;
extract, from the data set, feature terms and numerical descriptors representing characteristics of the item entity, and construct a prompt data structure by inserting the extracted feature terms into a predefined instruction template to form input for a generative information processing model;
transmit the prompt data structure to the generative information processing model via the communication interface, obtain generated text data from the generative information processing model, and store the generated text data in the data set in association with the item entity;
transmit the generated text data as a notification data packet to the remote terminal, receive correction data from the remote terminal, and update the generated text data in the data set based on the correction data;
upon receiving state information indicating a distribution state from the remote terminal, make content data reflecting the correction data distributable via a web provision interface coupled to the packet-switched network;
acquire interaction log records from the web provision interface and compute an effectiveness index based on the interaction log records, and dynamically update the prompt data structure based on the effectiveness index; and
acquire user interaction data from the remote terminal, perform affective state estimation processing on the user interaction data to estimate an emotional state of a user, and adjust at least one parameter of the prompt data structure based on the estimated emotional state.

19. The system according to claim 18, wherein the item entity is a merchandise item, the generated text data includes a product description and a promotional text, and the web provision interface is configured to distribute the content data to an electronic commerce platform.

20. A method performed by circuitry, the method comprising:
receiving, via a communication interface coupled to a packet-switched network, media data and structured attribute records associated with an item entity from a remote terminal, performing format conversion processing on the media data, and registering the converted media data and the structured attribute records in association with the item entity in a data set stored on a storage device;
extracting, from the data set, feature terms and numerical descriptors representing characteristics of the item entity, and constructing a prompt data structure by inserting the extracted feature terms into a predefined instruction template to form input for a generative information processing model;
transmitting the prompt data structure to the generative information processing model via the communication interface, obtaining generated text data from the generative information processing model, and storing the generated text data in the data set in association with the item entity; and
transmitting the generated text data as a notification data packet to the remote terminal, receiving correction data from the remote terminal, updating the generated text data in the data set based on the correction data, and, upon receiving state information indicating a distribution state, making content data reflecting the correction data distributable via a web provision interface coupled to the packet-switched network.
